(19) United States
(12) Patent Application Publication
(10) Pub. No.: US 2007/0298380 A1
(43) Pub. Date: Dec. 27, 2007

(54) Dental treatment devices adapted for improved lingual side adhesion

(75) Inventor: Peter M. Allred, Riverton, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Ultradent Products, Inc., South Jordan, UT (US)

(21) Appl. No.: 11/474,759

(22) Filed: Jun. 26, 2006

(51) Int. Cl. A61C 5/00

(52) U.S. Cl. 433/215

(57) ABSTRACT

Dental treatment devices in the shape of a dental tray, strip or patch include a barrier layer, a dental treatment composition, and an adhesive composition near a lingual rim of the barrier layer in order to better maintain the barrier layer adjacent to lingual tooth surfaces. The barrier layer protects the treatment and protective adhesive compositions from saliva or moisture during use. The dental treatment composition is positioned so as to contact a person's labial and lingual tooth surfaces when the treatment device is in use. The adhesive composition overcomes disruptive mechanical forces that are caused by a person's tongue while the barrier layer is positioned over the person's teeth. The treatment composition and adhesive composition preferably include a hydrophilic tissue adhesion polymer.

### BACKGROUND OF THE INVENTION

1. The Field of the Invention

This invention is in the field of dental treatment devices used to treat a person's teeth and/or gums. More particularly, the invention relates to treatment devices that include a moisture-resistant barrier layer, a treatment gel, and a hydrophilic adhesive composition near a lingual edge of the barrier layer to reliably maintain the lingual side of the barrier layer against lingual tooth surfaces during use.

2. The Relevant Technology

Virtually all people desire white or whiter teeth. To achieve this goal, people either cover their teeth with veneers or chemically bleach their teeth. A common treatment method involves the use of a custom-fitted dental tray. One type of customized tray is made from a stone cast of a person's teeth. Another is customized directly using a person's teeth as a template (e.g., “boil-and-bite” trays). Non-customized trays that approximate the shapes and sizes of a variety of users' dental arches have also been used. A dental treatment composition is placed into the tray and the tray placed over the person's teeth for a desired period of time.

Another treatment method involves painting a treatment composition directly onto a person's teeth. A perceived advantage of paint-on treatment is that it eliminates the dental tray. A disadvantage is that the paint-on treatment composition remains directly exposed to saliva and disruptive forces in a person's mouth. As a result, the treatment composition may not remain on the teeth where treatment is desired buy may dissolve away into the person's saliva and/or be transferred to adjacent oral tissues, potentially irritating soft oral tissues.

Another tooth treatment method involves placing a flexible treatment strip over a user's tooth surfaces. Conventional treatment strips comprise a flexible plastic strip coated with a dental treatment gel of moderate viscosity and relatively low stickiness on the side of the strip facing the user's teeth. To install the treatment strip, a portion of the treatment strip is placed over the front surfaces of the user's teeth, and the remainder is folded around the occlusal edges of the teeth and against a portion of the lingual surfaces. Like paint-on treatment compositions, this procedure does not require the use of dental trays. Unlike paint-on treatment compositions, treatment strips include a plastic barrier that, at least in theory, keeps the dental treatment gel from diffusing into the user's mouth.

In reality, because of the generally poor adhesion of treatment strips to the user's teeth, coupled with their generally flimsy nature, it is often difficult for the user to maintain the treatment strip in its proper position for the recommended time. Conventional treatment strips are prone to slip off the teeth as a result of even minimal movement of the user's mouth, jaw or tongue. Indeed, it is recommended that the user not eat, drink, smoke or sleep while wearing the treatment strip. It is difficult to talk or smile while maintaining the treatment strip in the correct position.

Even if a user successfully maintains a conventional treatment strip in its proper position during the recommended treatment period, the treatment gel can diffuse into the person's saliva, potentially causing a poor taste in the user's mouth and possibly discomfort to soft oral and throat tissues. The tendency of the treatment gel to diffuse into the user's mouth can be accelerated through even minimal shifts of the treatment strip over the user's teeth, with each shift potentially causing treatment gel that remains adhered to the user's teeth, but not covered by the plastic strip, to be exposed to saliva in the user's mouth. In some cases, the treatment strip can become so dislodged or mangled that it must be removed by the user and replaced with a fresh treatment strip to complete the recommended treatment time. This multiplies the cost and hassle of using conventional treatment strips.

Ultimately, the main impediment to successful treatment is the failure of users to complete the prescribed treatment regimen. If the treatment apparatus is difficult to install over a person's teeth, requires numerous repetitions to achieve observable results, or is uncomfortable to wear, the user may simply give up and prematurely abort the prescribed treatment regimen. Treatment strips and thin-walled, non-custom trays are especially vulnerable to lingual movements that disrupt adhesion of the barrier layer against lingual tooth surfaces. Thus, even if properly placed, a treatment device can peal away from the person's tooth surfaces, particularly on the lingual side of the person's teeth, thereby exposing the treatment composition to saliva. Once diluted with saliva, the treatment composition, even if initially adhesive, quickly loses its ability to hold the barrier layer against the teeth.

In view of the foregoing, there is an ongoing need for improved treatment apparatus that properly remain in position over the user's teeth, particularly devices that reliably remain adhered to a user's lingual tooth surfaces so as to prevent diffusion of the treatment composition into a user's oral cavity. Such improvements would be expected to improve or encourage compliance by the user.

### BRIEF SUMMARY OF THE PREFERRED EMBODIMENTS

The present invention relates to dental treatment devices used to treat a person's teeth and/or gums that include a barrier layer, a treatment gel positioned so as to contact a person's tooth surfaces, and a hydrophilic adhesive composition positioned near a lingual edge of the barrier layer so as to better maintain adhesion of the lingual side of the barrier layer against a person's lingual tooth surfaces and/or gums during use. The barrier layer protects the treatment gel from being diluted with saliva during use. The hydrophilic adhesive region reliably adheres to moist oral tissue and helps keep the barrier layer from pealing away from lingual tooth surfaces as a result of mechanically disruptive forces typically caused by a person's tongue brushing against the lingual side of the barrier layer during use.

The barrier layer is advantageously formed from a moisture-resistant polymer material, examples of which include polyolefins, polyesters, ethylene-vinyl acetate copolymer (EVA), polyurethane, other polymers, and blends thereof. It may be in the form of a dental tray, strip, patch or other desired shape. The barrier layer is advantageously thin and flexible so as to conform to the shape of a person's dental arch as a result of the adhesive nature of the treatment and adhesive compositions. The barrier layer may be sufficiently resilient as to assume a particular shape prior to use, or it may be so thin and flexible as to only be capable of assuming the shape of an internal support (e.g., the shape of a highly viscous or solid treatment composition and/or adhesive composition) and/or an external support (e.g., an exoskeleton, such as an external support tray). In one embodiment, the barrier layer is reliably held in place over a user's teeth for a desired period of time by the adhesive action of the treatment composition and/or adhesive composition.

The treatment gel may comprise a bead, a continuous layer, or a plurality of discontinuous regions or islands. Although treatment gels used in the treatment devices of the invention can have any desired viscosity and/or stickiness, treatment gels are preferably thick and sticky so as to act as a highly viscous glue or adhesive that adheres to teeth and helps to hold the barrier layer against tooth surfaces during use.

Treatment gels according to the invention comprise an active treatment agent, a tissue adhesion agent, a liquid or gel solvent or carrier, and other active agents, inert ingredients or adjuvents as desired. Whether the treatment composition is a thick or runny gel depends on the relative concentrations of the tissue adhesion agent and the solvent or carrier. Increasing the ratio of solvent or carrier relative to the tissue adhesion agent generally decreases the viscosity of the composition, while decreasing the ratio of solvent or carrier relative to the tissue adhesion agent increases viscosity.

The hydrophilic adhesive composition may be a sticky, viscous gel or a substantially solid composition. It is generally applied near a lingual facing edge of the barrier as a continuous strip or bead so as to provide adhesion across the entire length of the lingual side of the barrier layer during use. When substantially solid, the adhesive composition can be a true solid or a highly viscous putty. The substantially solid form of the adhesive composition can become more adhesive to teeth and/or soft oral tissue when moistened with saliva. The adhesive composition includes a tissue adhesion agent, a liquid or gel solvent or carrier, and optionally one or more active agents, inert components, and adjuvents as desired.

The hydrophilic adhesive composition typically includes either not treatment agent or a reduced amount compared to the treatment composition so as to minimize or reduce diffusion of the treatment agent into the oral cavity during use. The adhesive composition forms a more reliable barrier that shields the treatment composition from saliva during use. This allows the inventive treatment devices to include higher concentrations of treatment agent that might otherwise diffuse into the oral cavity absent the adhesive composition.

The size and shape of the inventive treatment devices can be tailored to more readily fit a person's upper or lower dental arch. They can fit differently-sized or shaped dental arches among different people. They are substantially devoid of structures corresponding to the size and shape of a person's unique dentition so that the treatment devices are designed to comfortably fit over a plurality of differently-sized dental arches corresponding to different people. The treatment devices are designed so as to substantially cover the front and lingual surfaces of a person's teeth, and optionally so as to overlap the gingival margin. Treating both surfaces yields more esthetically appealing teeth and helps treat interproximal spaces between adjacent teeth.

In one embodiment, the treatment devices are in the shape of a dental tray having a front side wall, a rear side wall, a bottom wall interconnecting the front and rear side walls, and a trough or space defined by the front, rear and bottom walls. In another embodiment, the treatment device may be in the shape of a substantially flat strip or patch prior to use. A strip of adhesive composition near a lingual rim or edge of either device helps retain the device over lingual tooth surfaces.

The treatment devices can be designed to be worn for any desired time period. In general, increasing the concentration of treatment agent within the treatment composition reduces the time required to effect a desired treatment. Nevertheless, due to the comfortable fit and reliable adhesion between the treatment devices and a person's teeth, it is possible to wear such devices for extended periods of time to ensure even and thorough treatment. Dental treatment devices according to the invention can be designed to be worn while, e.g., talking, sleeping, eating, drinking, smiling, frowning, grimacing, yawning, coughing, smoking, or making virtually any facial expression or mouth contortion. This greatly decreases their intrusiveness into everyday activities compared to conventional treatment strips, which adhere poorly to teeth, or intrusive treatment devices such as large, bulky treatment dental appliances.

The dental treatment devices can be designed to be worn for as little as a few minutes or as long as several hours. By way of example, not limitation, a typical treatment session of fast duration may last from about 10 to about 30 minutes. A treatment session of intermediate duration may last from about 30 minutes to about 2 hours. A treatment session of long duration, including professional treatment or overnight treatment while a person is sleeping, may last from about 2 hours to about 12 hours. Treatment sessions may be repeated as many times as are needed or desired. In some cases, a clinical effect can be observed after only 1-3 treatment sessions. A typical treatment regimen will preferably include 1-20 treatment sessions, more preferably 2-15 treatment sessions, and most preferably 3-10 treatment sessions.

For convenience of use, multiple treatment devices may be packaged together and sold as a kit. The number of treatment devices can equal the number of sessions of a prescribed treatment regimen. Multiple treatment devices can be stacked, internested, or laid together within a package. Thy can be sealed collectively or individually. They may contain a removable protective layer on an interior surface to protect the treatment composition from contamination or moisture.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings, in which:

FIG. 1 is a perspective view of an exemplary dental treatment device according to the invention in the shape of a dental tray comprising a barrier layer, a treatment gel, and a hydrophilic adhesive composition near the lingual rim of the rear side wall;

FIG. 2A is a cross-sectional view of the dental treatment device of FIG. 1;

FIG. 2B is a cross-sectional view of en exemplary treatment device according to the invention that includes a barrier layer, multiple spots or regions of a treatment gel, and a continuous strip of an adhesive composition near the lingual rim;

FIG. 3 illustrates a dental treatment device according to the invention contained within a sealed protective package having a peelable cover;

FIG. 4 is a perspective view of an exemplary dental treatment device having an L-shaped trough, a curved longitudinal profile, and notches in the rims;

FIG. 5 is a perspective view of an exemplary dental treatment device having a U-shaped trough and a substantially straight longitudinal profile;

FIG. 6 is a perspective view of an exemplary dental treatment device having a V-shaped trough and a curved longitudinal profile;

FIG. 7 is a perspective view of an exemplary dental treatment device according to the invention in the shape of a strip or patch comprising a barrier layer, a dental treatment composition, and an adhesive composition near a lingual edge;

FIG. 8A is a cross-sectional view of the dental treatment device of FIG. 8;

FIG. 8B is a perspective view of an exemplary treatment device according to the invention that includes a barrier layer, multiple spots or regions of a dental treatment composition, and a continuous strip of an adhesive composition nearer a lingual edge;

FIG. 9 illustrates multiple treatment strips or patches according to the invention contained within a sealed, protective package having a peelable cover;

FIG. 10 illustrates a treatment strip or patch according to the invention being manipulated so as to have an approximate V-shaped cross section prior to placement over a person's teeth;

FIG. 11 illustrates a person placing a dental treatment device according to one embodiment of the invention over the upper dental arch;

FIG. 12 illustrates a person after placing dental treatment devices over the upper and lower dental arches; and

FIG. 13 is a cross-sectional view illustrating a dental treatment device according to the invention covering the labial and lingual surfaces of a tooth, with a treatment gel in contact with both surfaces and an adhesive composition in contact with oral tissue at the gingival margin.

### DETAILED DESCRIPTION OF THE PREFERRED EMBODIMENTS

### I. INTRODUCTION AND DEFINITIONS

The present invention relates to improved dental treatment devices used to treat a person's teeth and/or gums. The treatment devices include a moisture-resistant barrier layer, a treatment gel positioned so as to contact a person's tooth surfaces, and an adhesive composition that is advantageously hydrophilic positioned near a lingual edge of the barrier layer in order to reliably maintain the barrier layer against lingual tooth surfaces during use. The barrier layer protects the treatment composition and adhesive composition from saliva or moisture within a person's mouth during use, which keeps them in contact with the person's teeth and/or surrounding soft tissue and helps prevent or minimize their diffusion into the user's oral cavity. The hydrophilic adhesive region reliably adheres to moist oral tissue and helps keep the barrier layer from pealing away from lingual tooth surfaces as a result of mechanically disruptive forces typically caused by a person's tongue brushing against the lingual side of the barrier layer during use.

The inventive treatment devices are more adhesive to teeth than conventional dental treatment strips and are less intrusive than bulky, over-the-counter, non-custom or boil-and-bite dental trays. In some cases they may be as reliable as, or even more reliable than, custom-fitted dental trays in maintaining a treatment composition against a person's teeth. To some people they may be at least as comfortable as custom-fitted trays.

The term “barrier layer”, as used herein, refers to one or more layers of a material that protects the treatment gel and adhesive region from ambient moisture and saliva found within a person's mouth when the dental treatment device is placed over the person's teeth. The barrier layer may also serve to protect the treatment and adhesive compositions from moisture and contaminants during storage and prior to use. The barrier layer may be in any desired form including, but not limited to, a dental tray, a tray-like shape, a strip or a patch. The terms “strip” and “patch” are essentially synonymous and refer to barrier layers and treatment devices that are essentially flat or formless prior to placing the treatment device over a person's teeth.

The term “gel” shall refer to treatment and/or adhesive compositions that have been formulated or processed so as to be flowable, either by the force of gravity (i.e., having no yield stress) or that do not flow by the force of gravity but which are viscous or plastic such that they can be shaped or manipulated (e.g., they can be expressed from a syringe orifice or other dispensing means known in the art). The term “gel” broadly encompasses a wide range of compositions having greatly varying viscosities, although treatment and adhesive gels according to the invention are preferably sufficiently thick or viscous that they will not run out or off of a dental tray, tray-like device or other barrier layer by gravity alone. In one embodiment, the treatment and/or adhesive gel may be rubbery or highly viscous. At some point, when the viscosity becomes so great as to yield a composition that is substantially solid (e.g., a stiff or highly viscous putty), the composition may be considered to be “substantially solid”.

The term “substantially solid”, as used herein, refers to a treatment composition or adhesive composition or region that is in a solid or semi-solid condition. In one aspect, a “substantially solid” composition or region can be characterized as a cohesive mass that does not readily flow or separate when subjected to gravitational forces and which cannot be readily expressed through a syringe outlet or other similarly-sized opening or orifice. Thus, the term “substantially solid” excludes runny adhesive liquids, viscous adhesive liquids, and even thick adhesive gels that are able to flow when subjected to gravity and/or which can be readily expressed through a syringe outlet or other similarly-sized opening or orifice. The term “substantially solid”, when used in the context of a treatment composition or adhesive composition, also excludes dry particulate compositions or powders because dry particulates and powders readily flow when subjected to gravity and/or are readily separated (i.e., the particles as a whole have little or no internal cohesion). Moreover, powders or particulates, when viewed as a whole, are not coherent or solid.

In one embodiment, the “substantially solid” compositions or regions become more adhesive when moistened with saliva or water. When moistened, the surface of the substantially solid composition or region turns into a sticky material that is able to more strongly adhere to teeth compared to a substantially solid composition or region that has not been moistened. The substantially solid composition may, at least on the surface, become a viscous liquid, paste or gel, at least temporarily, depending on the amount of moisture that is applied to the surface of the “substantially solid” composition or region. The consistency of the moistened surface can remain “substantially solid” depending on the degree of initial moistening, or it can stiffen and even revert back to being “substantially solid” as the initial quantity of surface moisture diffuses into a remaining portion of the “substantially solid” composition or region over time (e.g., during a treatment procedure in which the composition is protected from saliva and ambient moisture in a person's mouth by a moisture-resistant barrier layer).

The term “dental tray”, as used herein, refers to a treatment device having a tray-like shape so as to facilitate placement of the device over at least a portion of a person's dental arch. A “dental tray” or “tray-like” device includes a front side wall configured to engage front surfaces of a person's teeth when in use, a rear side wall extending laterally from the front side wall, either abruptly by one or more distinct angles or non-abruptly by a bottom wall or curved transition portion, configured to engage lingual surfaces of the person's teeth, and a trough between said front and rear side walls. A “dental tray” may be configured so that a portion of the front side wall, rear side wall, or transition portion (e.g., a bottom wall), engages the incisal or occlusal edges of the person's teeth when in use. The dental tray may be curved or straight in a longitudinal dimension.

The term “trough”, as used herein, refers to the region that is at least partially bounded by the front side wall, the rear side wall, and a plane or imaginary curved dome extending from an upper edge of the front side wall and an upper edge of the rear side wall. Thus, a “trough” can theoretically exist whenever the front and rear side walls have a space therebetween and are laterally offset by an angle of less than 180°. In practice, the front and rear side walls will be offset by an angle that is preferably less than about 150°, more preferably less than about 120°, and most preferably less than about 90°.

In the case where the front and rear side walls are connected by a transition portion (e.g., a trough having a U-shaped or rectangular cross section), at least a portion of the front and rear side walls may be substantially parallel (i.e., be offset by an angle of approximately 0°) or offset by a very small angle. In the case of a trough having a V-shaped or trapezoidal cross section, at least a portion of the front and rear side walls may be offset by an acute angle (i.e., by an angle between 0-90°). In the case of a trough having an L-shaped cross section, at least a portion of the front and rear side walls may be offset by an angle centered around approximately 90° (e.g., by an angle in a range of about 70° to about 110°). Thus, a trough having an L-shaped cross section can be a subset or slight variation of a trough having a V-shaped cross section.

The terms “longitudinal”, “longitudinal dimension” and “longitudinal profile”, as used herein when referring to a dental tray or treatment device, shall refer to the lengthwise dimension of the tray or device. The tray or device may be straight in the “longitudinal dimension” or it may be horseshoe-shaped or otherwise “longitudinally curved” in the longitudinal dimension so as to approximate the curvature of a person's dental arch, or at least facilitate placement of the tray or device over the dental arch.

The terms “strip” or “patch” are used interchangeably and shall refer to any barrier layer or treatment device that is substantially flat, or that only has a slight curvature or bend but that does not constitute a “dental tray”, as that term is understood in the art. A “strip” or “patch”, includes an inner surface or region generally oriented toward the front and/or rear surfaces of a person's teeth and/or gums when in use and an outer surface that is generally oriented away from the person's teeth and/or gums. A “strip” or “patch” may be configured so that a portion of the inner surface is oriented toward the incisal or occlusal edges of the person's teeth during use. The strip or patch may be curved or straight in one or both of the lengthwise and widthwise directions in order to fit over a user's teeth and/or gums in a desired manner.

The term “molecular weight”, as used herein, shall refer to number average molecular weight expressed in Daltons, unless otherwise specified.

### II. DENTAL TREATMENT DEVICES

Dental treatment devices according to the invention include a barrier layer that protects a treatment gel and adhesive composition from ambient moisture within a person's mouth during use. The treatment gel is positioned adjacent to the barrier layer in a manner so as to contact both tooth surfaces to be treated, and the adhesive composition is positioned adjacent to the barrier layer near the lingual rim or edge of a treatment tray or strip so as to reliably maintain the barrier layer against lingual tooth surfaces (e.g., so as to overcome the tendency of the lingual portion of the barrier layer from peeling away from lingual tooth surfaces as a result of disruptive mechanical forces caused by a person's tongue during use). The treatment composition is in gel form, and the adhesive composition can be a gel or substantially solid. Following are preferred examples of barrier layers, treatment compositions, and adhesive compositions according to the invention, as well as characteristics of treatment devices made therefrom.

A. Barrier Layers

The barrier layer can have any desired shape or thickness. It is preferably moisture-resistant in order to protect the treatment and adhesive compositions from ambient moisture found in a person's mouth. According to one embodiment, the barrier layer comprises a thin, flexible membrane formed from a moisture-resistant polymer material. The barrier layer may comprise a conventional dental tray, examples of which include both customized and non-custom dental trays, or it may initially be a strip or patch, or have some other configuration.

Examples of materials that can be used to form the barrier layer include, but are not limited to, polyolefins, wax, metal foil, paraffin, ethylene-vinyl acetate copolymer (EVA), ethylene-vinyl alcohol copolymer (EVAL), polycaprolactone (PCL), polyvinyl chloride (PVC), polyesters, polycarbonates, polyamides, polyurethanes, or polyesteramides. Examples of suitable polyolefins that can be uses to make the barrier layer include, but are not limited to, polyethylene (PE), high density polyethylene (HDPE), low density polyethylene (LDPE), ultra low density polyethylene (ULDPE), polypropylene (PP), and polytetrafluoroethylene (PTFE) (e.g., TEFLON). An example of a suitable polyester for use in making the barrier layer includes, but is not limited to, polyethylene terephthalate (PET), an example of which is MYLAR, sold by DuPont. An example of a suitable polyurethane barrier material is a polyurethane film manufactured by ArgoTech, which is located in Greenfield, Mass. The barrier layer may comprise a polymeric blend and/or multiple layers comprising two or more of the foregoing materials. Plasticizers, flow additives, and fillers known in the art can be used as desired to modify the properties of any of the foregoing polymers used to form the barrier layer.

According to one embodiment, the barrier layer is formed of a mixture of ethylene-vinyl acetate copolymer (EVA) and polypropylene (PP), preferably comprising about 5% to about 35% PP, more preferably about 10% to about 30% PP, more especially preferably about 15% to about 25% PP, and most preferably about 20% PP, with the balance comprising ethylene-vinyl acetate (EVA), and optionally other polymers and/or small quantities of additives such as plasticizers.

Other materials that can act as a barrier layer include cellulosic ethers, cellulose acetate, polyvinyl acetate, polyvinyl alcohol, shellac, and chemical or light-cure materials (e.g., methacrylate or acrylate resins). Examples of useful cellulosic ethers that can be used to form a barrier layer include, but are not limited to, ethyl cellulose, propyl cellulose, isopropyl cellulose, butyl cellulose, t-butyl cellulose, and the like.

In general, the thickness of the barrier layer can be selected to yield a dental treatment device having a desired level of strength, rigidity, resilience, and flexibility. In order for the barrier layer to be sufficiently flexible so as to conform to a person's teeth as result of adhesive action by the treatment composition and/or adhesive composition, the barrier layer will preferably have a thickness ranging from about 0.025 mm to about 1.5 mm, more preferably in a range of about 0.05 mm to about 1 mm, and most preferably in a range of about 0.1 mm to about 0.75 mm.

### B. DENTAL TREATMENT COMPOSITIONS

The treatment compositions within the treatment devices according to the invention may comprise any treatment composition known in the art. Preferred treatment gels are those that are substantially viscous and tacky in order to assist the adhesive composition region in retaining the treatment device against a person's teeth during use. The treatment compositions may comprise a continuous layer or bead positioned so as to cover a person's front tooth surfaces, rear tooth surfaces, or both, or they may comprise separate beads, layers or islands separated by one or more spaces. The treatment composition is advantageously positioned directly adjacent to the barrier layer.

In general, dental treatment gels will include at least one dental treatment agent, at least one tissue adhesion (or thickening) agent, and a liquid or gel, solvent, carrier or vehicle into which the dental treatment agent and tissue adhesivion agent are dispersed. The treatment gel may optionally include other active agents (e.g., desensitizing agents, remineralizing agents, antimicrobial agents, and the like), as well as inert ingredients (e.g., plasticizers, humectants, neutralizing agents, thickening agents, flavorants, sweeteners, and the like).

Exemplary dental treatment gels, and methods for making such gels, which may be used to manufacture the treatment compositions and devices according to the invention are disclosed in U.S. Pat. No. 5,376,006; U.S. Pat. No. 5,785,527; U.S. Pat. No. 5,851,512; U.S. Pat. No. 5,858,332; U.S. Pat. No. 5,985,249; U.S. Pat. No. 6,306,370; U.S. Pat. No. 6,309,625; U.S. Pat. No. 6,312,671; U.S. Pat. No. 6,322,774; U.S. Pat. No. 6,368,576; U.S. Pat. No. 6,387,353; U.S. Pat. No. 6,500,408; and U.S. Pat. No. 6,503,485. For purposes of disclosing dental treatment gels, and methods of making such gels, the foregoing patents are incorporated herein by reference.

Following are preferred treatment agents, tissue adhesion agents, solvents or carriers, and other components within preferred treatment compositions used to manufacture dental treatment devices according to the invention.

1. Treatment Agents

Any treatment agent capable of treatment teeth can be used. Examples include dental bleaching agents, desensitizing agents, antimicrobial agents, anticariogenic agents, and the like. A common dental bleaching agent that is known to bleach teeth and that has been found to be safe for oral use is hydrogen peroxide. However, stable hydrogen peroxide does not itself exist free in nature, but as an aqueous solution or a complex. Aqueous hydrogen peroxide is an acceptable dental treatment agent to the extent that an anhydrous treatment composition is not desired. Non-limiting examples of hydrogen peroxide complexes include carbamide peroxide and metal perborates (e.g., sodium perborate). Other bleaching agents that can be used to bleach teeth include, but are not limited to, metal percarbonates (e.g., sodium percarbonate), metal peroxides (e.g., calcium peroxide), metal chlorites and hypochlorites, peroxy acids (e.g., peroxyacetic acid), and peroxy acid salts.

The bleaching agent can have any desired concentration, e.g., between 1-90% by weight of the treatment composition. The concentration of the dental bleaching agent can be adjusted depending on the intended treatment time for each treatment session. In general, the shorter the treatment time, the more bleaching agent will be added to accelerate dental bleaching so as to effect treatment in a shorter time period. The one or more bleaching agents are preferably included in an amount in a range of about 1% to about 60% by weight of the dental bleaching composition, more preferably in a range of about 5% to about 40% by weight, and most preferably in a range of about 10% to about 30% by weight.

The treatment gel may include one or more other active agents instead of, or in addition to, the bleaching agent to yield treatment compositions having desired properties. Examples of other active agents include, but are not limited to, desensitizing agents (e.g., potassium nitrate, other potassium salts, citric acid, citrates, and sodium fluoride), remineralizing agents (e.g., sodium fluoride, stannous fluoride, sodium monofluorophosphate, and other fluoride salts), antimicrobial agents (e.g., chlorhexidine, troclosan, and tetracycline), antiplaque agents, anti-tartar agents (e.g., pyrophosphates salts), and other medicaments. Such active agents may be includes in amounts customary in the art of dental treatments.

2. Tissue Adhesion Agents

Useful tissue adhesion agents (or tackifying agents), which can also act as thickening agents that increase the viscosity of the dental treatment gel, include a wide variety of hydrophilic polymers. Examples of hydrophilic polymer tissue adhesion agents include, but are not limited to, polyvinyl pyrrolidone (PVP), PVP-vinyl acetate copolymers, carboxypolymethylene (e.g., CARBOPOL, sold by Novean, Inc.), polyethylene oxide (e.g., POLYOX, made by Union Carbide), polyacrylic acid polymers or copolymers (e.g., PEMULEN, sold by Novean, Inc.), polyacrylates, polyacrylamides, copolymers of polyacrylic acid and polyacrylamide, carboxymethylcellulose, carboxypropylcellulose, cellulosic ethers, polysaccharide gums, proteins, and the like.

Non-limiting examples of polyvinyl pyrrolidone polymers that have been used in formulating dental treatment compositions according to the invention include Kollidon 30, a polyvinyl pyrrolidone polymer sold by BASF having a molecular weight of 50,000, Kollidon VA 60, a polyvinyl pyrrolidone polymer having a molecular weight of 60,000, and Kollidon 90 F, a polyvinyl pyrrolidone polymer having a molecular weight of 1.3 million.

To form a gel having a desired rheology, the one or more tissue adhesion agents are preferably included in an amount in a range of about 1% to about 50% by weight of the dental treatment gel, more preferably in a range of about 3% to about 30% by weight, and most preferably in a range of about 5% to about 20% by weight.

3. Carriers and Vehicles

Dental treatment gels for use in making dental treatment devices according to the invention will typically include one or more liquid or gel, solvents, carriers or vehicles into which the dental treatment agent, tissue adhesion agent, and other components are dissolved or dispersed. The solvent, carrier or vehicle will typically comprise the balance of components in the dental treatment gel in addition to the treatment agent, tissue adhesion agent, and other components.

Examples of liquid or gel solvents, carriers or vehicles include, but are not limited to, water, alcohols (e.g., ethyl alcohol), and polyols (e.g., glycerin, sorbitol, mannitol, other sugar alcohols, propylene glycol, 1,3-propanediol, polyethylene glycol, polyethylene oxide, and polypropylene glycol).

4. Other Components

The treatment compositions may optionally include other components as desired to yield treatment compositions having desired properties. Examples include bleaching agent stabilizers (e.g., EDTA, salts of EDTA, citric acid and its salts, phosphoric acid and its salts, phenolphosphonic acid and its salts, gluconic acid and its salts, alkali metal pyrophosphates, alkali metal pyrophosphates, alkyl sulfates, such as sodium lauryl sulfate, tin salts, such as sodium stannate, and tartrates), neutralizing agents (e.g., sodium hydroxide and triethanolamine), inorganic thickening agents (e.g., fumed silica), humectants, flavorants, sweeteners, and the like.

C. Adhesive Compositions

The adhesive compositions used in manufacturing dental treatment devices according to the invention are characterized as having no treatment agent, or significantly less treatment agent, than the treatment gel. Aside from that, they may include any of the components set forth above with respect to the dental treatment gel. The adhesive composition is positioned near a lingual rim of the barrier layer so as to reliably maintain the barrier layer to lingual tooth surfaces during use, thereby better confining the treatment gel to an area adjacent to the person's tooth surfaces to be treated. The adhesive composition is preferably hydrophilic in order to more reliably adhere to moist oral tissues, such as teeth and/or gums.

The adhesive composition can be a gel or substantially solid. It is preferably a continuous bead or layer to provide continuous adhesion of the lingual edge of the barrier layer. The main difference between an adhesive composition that is a “gel” or “substantially solid” is the level of solvent or carrier within the composition. In general, the greater the concentration of solvent or carrier relative to the tissue adhesive agent, the less viscous the gel. The lower the concentration of solvent or carrier relative to the tissue adhesion agent, the more viscous the gel. At some point, the ratio of solvent or carrier to tissue adhesion agent is low enough so that the composition is or becomes a stiff or highly viscous putty, which may be characterized as being “substantially solid”. Stiff putties preferably become more adhesive to teeth when moistened with water or saliva. Substantially solid adhesive compositions can have so little solvent or carrier as to feel dry to the touch and be initially non-adhesive but then become adhesive to teeth when moistened with water or saliva. Substantially solid adhesive compositions can be made by initially including a very small amount of solvent or carrier and/or by first forming an adhesive gel that is later dried to remove a substantial portion of the solvent or carrier.

Examples of substantially solid adhesive compositions that can be used to reliably maintain a barrier layer against a person's lingual tooth surfaces are disclosed in U.S. application Ser. No. 10/637,237, filed Aug. 8, 2003; U.S. application Ser. No. 10/646,484, filed Aug. 22, 2003; and U.S. application Ser. No. 10/646,443, filed Aug. 22, 2003. For purposes of disclosing substantially solid adhesive compositions, the foregoing applications are incorporated herein by reference. Examples of adhesive gel compositions are disclosed in U.S. Pat. No. 5,770,182; U.S. Pat. No. 5,855,870; U.S. Pat. No. 5,851,512; U.S. Pat. No. 5,5,985,249; and U.S. Pat. No. 6,036,943. For purposes of disclosing adhesive gel compositions, the foregoing patents are incorporated herein by reference.

In the case where the adhesive composition is a gel, the concentration of tissue adhesion agent can fall within the ranges set forth above relative to the treatment gels. In the case where the adhesive composition is substantially solid, the one or more tissue adhesion agents are preferably included in an amount in a range of about 10% to about 90% by weight of the substantially solid adhesive composition, more preferably in a range of about 20% to about 80% by weight, and most preferably in a range of about 40% to about 75% by weight.

In adhesive compositions that are substantially solid, the concentration of solvent, carrier or vehicle will typically be attenuated compared to adhesive gels. Where it is desired to form an adhesive gel that is later converted into a substantially solid adhesive composition, it may be advantageous to include one or more volatile solvents that can be removed by evaporation (e.g., water, alcohols, acetone, and other organic solvents). Because of the affinity of hydrophilic polymers for water, even treatment compositions that appear to be solid may include a significant amount of bound water (e.g., up to about 10% or more by weight of the treatment composition). In the case where the treatment composition has the consistency of a highly viscous or stiff putty, the composition will generally include a solvent, carrier or vehicle that acts as a plasticizer or softening agent.

In general, adhesive compositions will include at least one tissue adhesion (or tackifying) agent and a liquid or gel solvent, carrier or vehicle into which the tissue adhesion agent is dispersed, at least in the case of a gel and/or during the manufacture of a substantially solid adhesive composition. The tissue adhesion agent preferably comprises a hydrophilic polymer (e.g., one or more of the hydrophilic polymers discussed above with respect to the dental treatment composition). The relative amount of tissue adhesion agent to liquid solvent, carrier or vehicle can be varied to yield either a gel or a substantially solid adhesive composition, as discussed above.

The solvent, carrier or vehicle may comprise any of the solvents, carriers or vehicles discussed above with respect to the treatment composition. The amount can be varied to yield either a gel or a substantially solid adhesive composition. An adhesive gel can be heated or otherwise processed to remove a substantially quantity of solvent or carrier to yield a substantially solid adhesive composition. In one embodiment, the substantially solid adhesive composition is initially non-adhesive or less adhesive but becomes more adhesive to teeth and soft oral tissues when moistened with saliva or water.

The adhesive composition may include a dental treatment agent, but typically in a lesser amount than the dental treatment gel. In that way, the portion of the tooth, if any, that contacts the adhesive composition rather than the treatment gel can still be subjected to tooth treatment. In addition, peroxide treatment agents are known to have an antimicrobial effect, thus potentially acting as a disinfecting and freshening agent to gums and periodontal tissue. The adhesive compositions may include a dental treatment agent in a range of 0% to about 10% by weight of the adhesive composition, preferably in a range of about 1% to about 10%, and more preferably in a range of about 5% to about 10% by weight.

The adhesive composition may include other components as desired, including colorants (e.g., carotene), gingival soothing agents (e.g., aloe vera, mild potassium nitrate, isotonic solution-forming. salts (e.g., sodium chloride in an amount of about 0.9% by weight), and anesthetics (e.g., benzocaine, lidocain and the like), antioxidants (e.g., vitamin A, vitamin C, vitamin E, other vitamins, chlorophyll and carotene), flavoring agents, antimicrobial agents and preservatives (e.g., sodium benzoate, parabens, triclosan, phenols, chlorhexidine, and cetylpyridinium chloride), mouth freshening agents (e.g., camphor and wintergreen), inorganic thickening agents (e.g., fumed silica and fumed aluminum oxide), remineralizing agents (e.g., sodium fluoride or other fluoride salts), treatment agent stabilizers, antiplaque agents, anti-tartar agents, and other adjuvents as desired.

The adhesive composition may optionally a bleaching agent activator that is released when the treatment device is moistened with saliva and/or mixed with the dental treatment gel upon placing the treatment device over the person's teeth. When peroxides are destabilized they more rapidly release oxygen radicals that cause tooth whitening. The treatment agent activator is advantageously retained within the adhesive composition prior to use (e.g., is locked within a substantially solid or gel matrix), but diffuses, leaches, or otherwise contacts, mixes or reacts with the bleaching gel upon moistening the bleaching and/or adhesive composition with saliva or water. The bleaching composition is initially substantially anhydrous and/or does not initially touch the adhesive composition in order to prevent diffusion or leaching of the bleaching agent activator into the bleaching composition prior to use.

An exemplary bleaching agent activator is a base, examples of which include oxides, hydroxides, carbonates, and bicarbonates of alkali metals and alkaline earth metals, and amines. Examples include sodium oxide, sodium hydroxide, potassium oxide, potassium hydroxide, sodium carbonate, sodium bicarbonate, ammonium hydroxide, magnesium hydroxide, sodium phosphate tribasic, and ethanolamine. Bases, when used as treatment agent activators, are preferably included in an amount in a range of about 0.1% to about 20% by weight of the adhesive composition, more, preferably in a range of about 1% to about 10% by weight, and most preferably about 7% by weight.

Another class of bleaching agent activator includes metals and metal compounds, such as transition metals (e.g., powders or fine particulates of iron, cobalt, nickel, copper, zinc, manganese, chromium, and the like) or metal compounds (e.g., halides or sulfates of iron, cobalt, nickel, copper, zinc, manganese, chromium, and the like). More specific examples include iron and manganese metal, manganese chloride, manganese citrate, ferrous sulfate, and manganese sulfate.

Another class of bleaching agent activator includes enzymes, particularly organo-metallic enzymes containing transition metals, such as iron. One example is “catalase”, which is described more particularly in U.S. Pat. No. 6,485,709 to Banerjee et al.

Metals, metal compounds, and organo-metallic enzymes, when used as a bleaching agent activator, are preferably included in an amount in a range of about 0.01% to about 20% by weight of the adhesive composition, more preferably in a range of about 0.05% to about 10% by weight, and most preferably in a range of about 0.1% to about 5% by weight.

In one embodiment, the adhesive composition includes both a bleaching agent activator and bleaching agent stabilizer. Where the bleaching composition directly contacts the adhesive composition, the effects of the bleaching agent stabilizer may predominate prior to moistening the adhesive composition and/or treatment gel with water or saliva. Thereafter, upon moistening the adhesive composition and/or treatment gel with water or saliva the effects of the bleaching agent activator may predominate. Many chemical reactions, including activating a peroxide bleaching agent, have a threshold activation energy requirement. The bleaching agent stabilizer can act to raise the activation energy requirement just enough to prevent or inhibit activation of the bleaching agent prior to moistening the adhesive composition or treatment gel with water or saliva but not so much as to prevent or inhibit activation after moistening occurs. This careful balance can be determined and optimized by testing adhesive compositions having varying concentrations of bleaching agent activator and bleaching agent stabilizer. Alternatively, the bleaching agent activator can be concentrated within the interior of the adhesive composition and/or the bleaching agent stabilizer can be concentrated at the surface of the adhesive composition.

D. Characteristics of Dental Treatment Devices

In one embodiment, the dental treatment devices according to the invention are in the shape of a dental tray having a front side wall, a rear side wall, and a trough between the front and rear side walls. Having the shape of a dental tray facilitates placement of the dental treatment device over a person's teeth by reducing the amount of manipulation necessary to obtain a good fit between the device and the person's teeth. They are substantially devoid of structures corresponding to the size and shape of a person's unique dentition so that the treatment devices are designed to comfortably fit over a plurality of differently-sized dental arches corresponding to different people. In another embodiment, the treatment devices are in the shape of a patch or strip. It is within the scope of the invention for the treatment devices to have any desired shape or configuration. In contrast to conventional treatment strips, which are not recommended for use while a person eats, drinks, smokes or sleeps, dental treatment devices according to the invention can be designed so as to be worn while talking, sleeping, eating, drinking, smiling, frowning, grimacing, yawning, coughing, smoking, or making virtually any facial expression or mouth contortion.

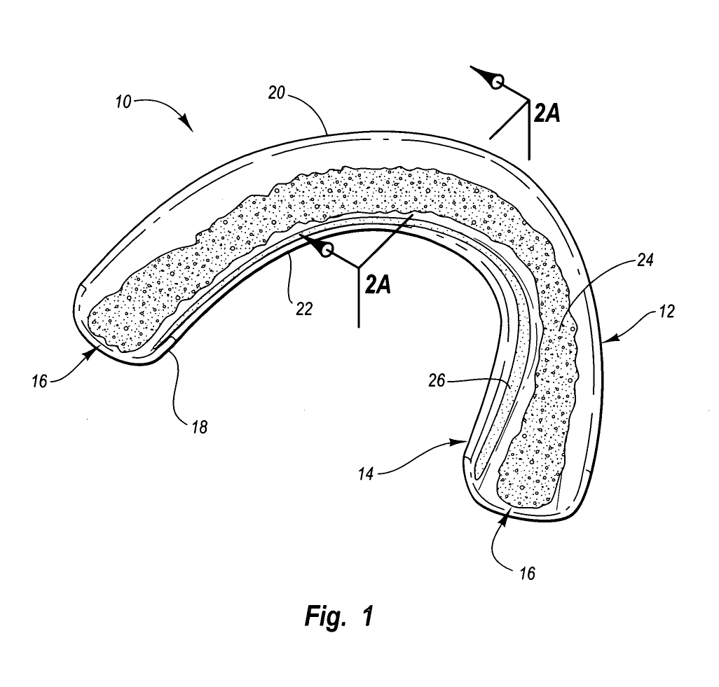

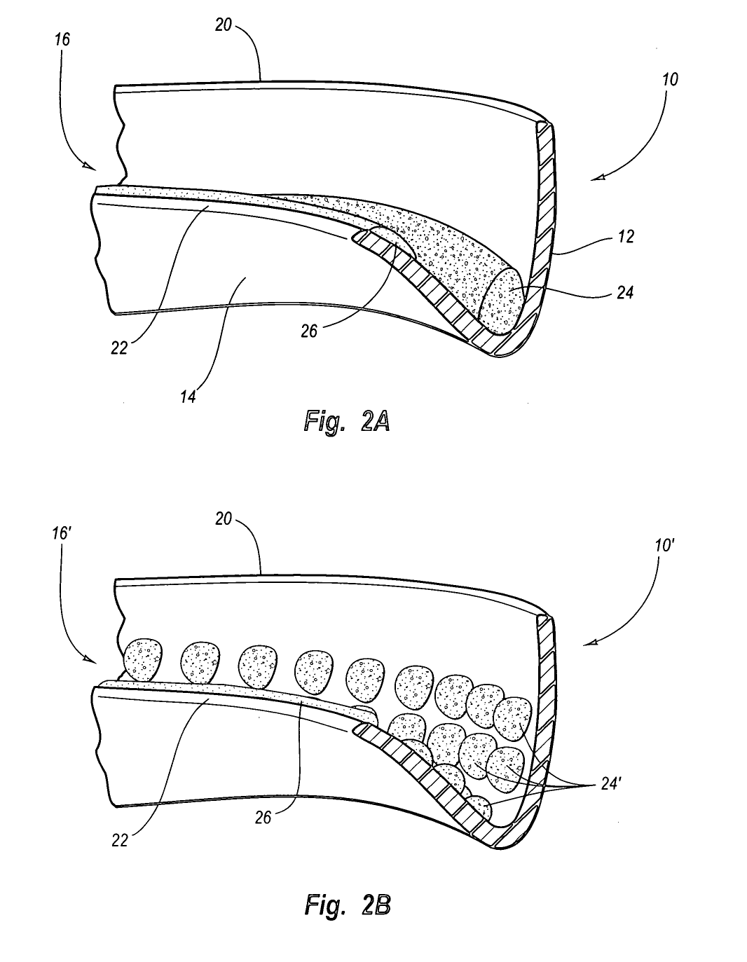

According to one embodiment, the dental treatment devices have a horseshoe shaped longitudinal profile and a trough with a U-shaped cross section, much like a conventional bleaching tray. An exemplary dental treatment device in the form of a dental tray is depicted in FIGS. 1 and 2A. FIG. 1 is a perspective view of a dental treatment device 10 having a front side wall 12 and a rear side wall 14 that together have a generally horseshoe shape in a longitudinal dimension and that define a trough 16 having a generally U-shaped cross section. The U-shaped cross section of the trough 16 is seen more clearly in FIG. 2A.

The dental treatment device 10 further includes a barrier layer 18, preferably comprising a moisture-resistant material, which has a front rim 20 and a back rim 22. In one embodiment, one or both of the front and back rims 20, 22 of the barrier layer are designed so as to terminate at or slightly beyond the gingival margin when the dental treatment device 10 is in use. A dental treatment composition 24 is positioned adjacent to the barrier layer and is included in an amount so as to contact both labial and lingual tooth surfaces during use. An adhesive composition or region 26 is positioned adjacent to the lingual rim 22 of the barrier layer 18 in order to reliably maintain the rear side wall adjacent to lingual tooth surfaces during use. The adhesive composition or region 26 also confines the treatment composition 24 so as to primarily or exclusively contact the lingual tooth surfaces of the teeth to be treated.

FIG. 2B alternatively depicts a dental treatment device 10′ that includes a barrier layer 18, regions or spots of a dental treatment composition 24′ and a continuous strip or region of an adhesive composition 26. Both the dental treatment composition 24′ and the adhesive composition 26 are located adjacent to the barrier layer. In this way, the dental treatment composition 24′ and adhesive composition 26 do not initially touch prior to use, thereby preventing or inhibiting contact between a bleaching agent activator that may optionally be included within the adhesive composition 26 and a bleaching agent within the treatment composition 24′ prior to use.

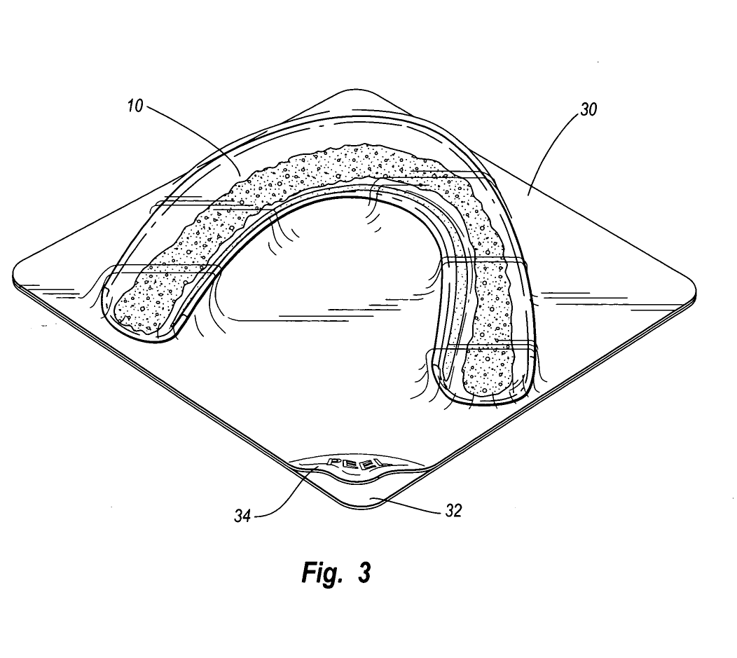

In order to protect dental treatment devices from contaminants during storage and prior to use, the treatment devices can be packaged within a sealed container or package. As illustrated in FIG. 3, a treatment device 10 according to the invention can be sealed within a protective package 30 that includes a rigid support layer 32 and a peelable cover 34. When it is desired to use the treatment device 10, the peelable cover 34 is removed and the treatment device 10 is removed or separated from the support layer 32.

In one embodiment, the support layer 32 includes a shaped portion that acts as exoskeleton to hold or maintain the treatment device 10 in the shape of a dental tray, or within a tray-like configuration, prior to use. In use, both the treatment device 10 and support layer 32 are placed into a person's mouth so as to initially position the treatment device over the person's teeth. Thereafter, the support layer 32 is removed, leaving only the treatment device 10 within the person's mouth. This permits further manipulation of the barrier layer 18 in order for the treatment device 10 to better conform to the shape and irregularities of the person's teeth.

In addition to, or instead of, the protective package 30, the treatment device may alternatively include a removable protective layer (not shown) that is temporarily placed within the trough adjacent to the dental treatment composition and adhesive composition. When it is desired to use the treatment device, the removable protective layer is removed so as to expose the treatment composition and adhesive composition.

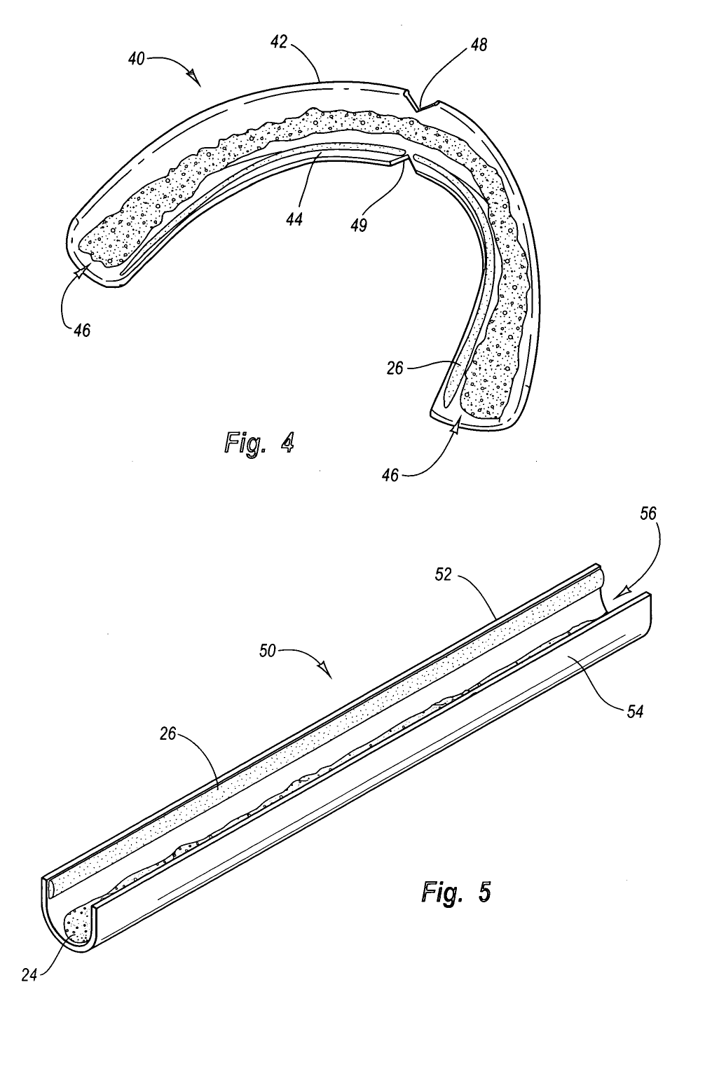

FIG. 4 illustrates an alternative embodiment of a dental treatment device 40 according to the invention that has an L-shaped cross section. The treatment device 40 includes a front side wall 42 and a rear side wall 44 extending laterally from the front side wall 42 so as to form a trough 46 having an approximate L-shaped cross section. The L-shaped treatment device 40 of FIG. 4 is somewhat easier to initially place over a person's dental arch compared to the U-shaped treatment composition or devices of FIGS. 1-3. This is due to the approximately planar orientation of the rear side wall 44 relative to the occlusal or incisal edges of a person's teeth when the front side wall 42 of the dental treatment device 40 is initially placed and adhered against the front surfaces of a person's teeth. On the other hand, more manipulation of the L-shaped treatment device 40 is generally required to form and adhere the rear side wall 44 against the lingual surfaces of the person's teeth as a result of the greater initial offset angle between the front side wall 42 and rear side wall 44. However, the ability of dental treatment devices according to the invention to adhere to tooth surfaces immediately after placement over a person's teeth as a result of including a strip of adhesive composition 26 near a lingual rim or edge facilitates conformation of the rear side wall 44 to the person's tooth lingual surfaces.

In the case of the dental treatment device 40 having an L-shaped cross section, it may be more correct to say that the rear side wall 44 extending laterally from the front side wall 42 is really a bottom wall rather than a rear side wall. Nevertheless, because this erstwhile “bottom wall” of an L-shaped treatment device is folded back against the lingual tooth surfaces during use, it can be readily seen that a treatment device having an L-shaped trough is merely a variation of a treatment device having a V-shaped trough. Thus, for purposes of this disclosure and the appended claims, the side wall 44 shall constitute, and fall within the definition of, a “rear side wall”.

To facilitate the ability of a dental treatment device to conform to the varying shapes and sizes among dental arches, the dental treatment device may include mechanical features such as one or more notches within the front or rear side walls. As shown in FIG. 4, a dental treatment device 40 includes a notch 48 near the center of the rim of the front side wall 42 and a notch 49 near the center of the rim of the rear side wall 44. Notches 48 and 49 allow the tray-like treatment or device to more easily spread open or compress when being conformed to differently-sized dental arches. In this way, the dental treatment device 40 can more easily be a “one-size fits all” composition or device.

FIG. 5 depicts an alternative embodiment of a dental treatment device 50 according to the invention, which includes a front side wall 52 and a rear side wall 54 that define a U-shaped trough 55 into which a bead of treatment gel 24 and strip of lingual adhesive gel 26 are placed. Instead of being horseshoe shaped like the dental treatment device of FIGS. 1-4, or otherwise having a curved longitudinal profile, the dental treatment device 50 of FIG. 5 has a substantially straight or linear longitudinal profile.

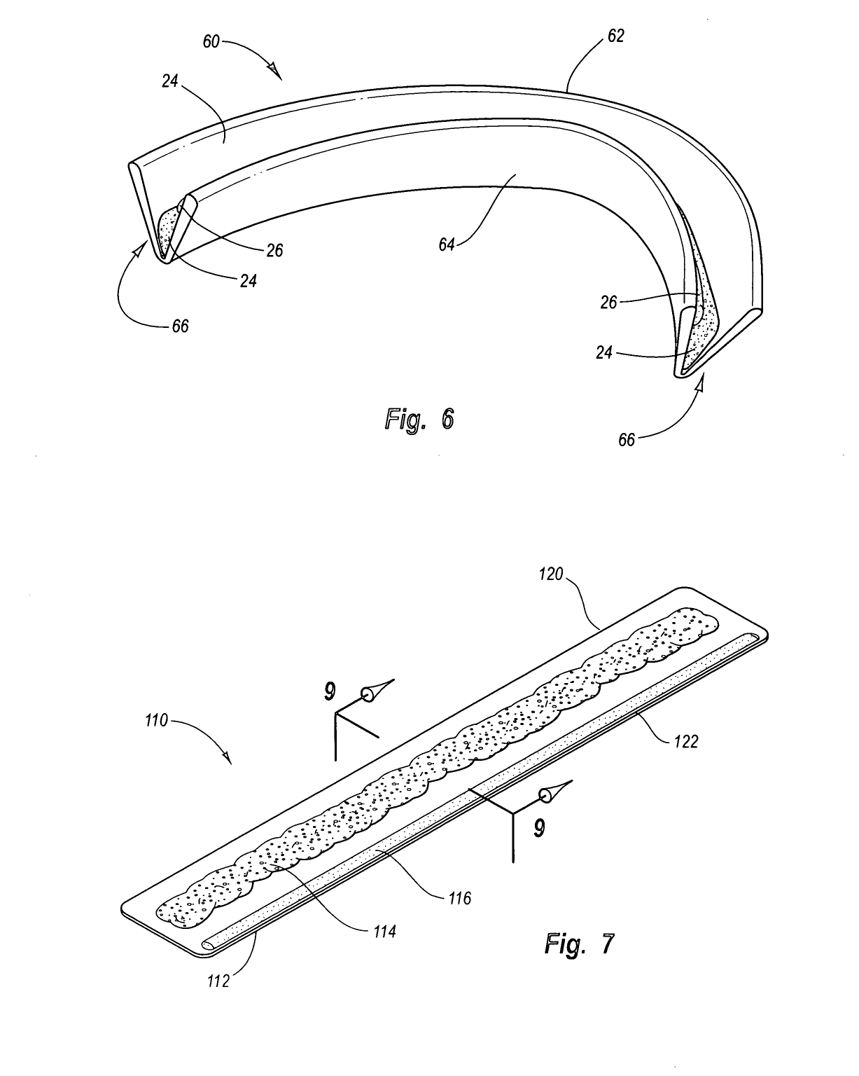

FIG. 6 depicts yet another alternative embodiment of a dental treatment device 60 according to the invention. The dental treatment device 60 includes a front side wall 62 and a rear side wall 64 that define a V-shaped trough 66 and a curved longitudinal profile. The main difference between the V-shaped treatment device 60 of FIG. 6 and the L-shaped treatment device 50 of FIG. 5 is the angle at which the front and rear side walls are laterally offset from each other.

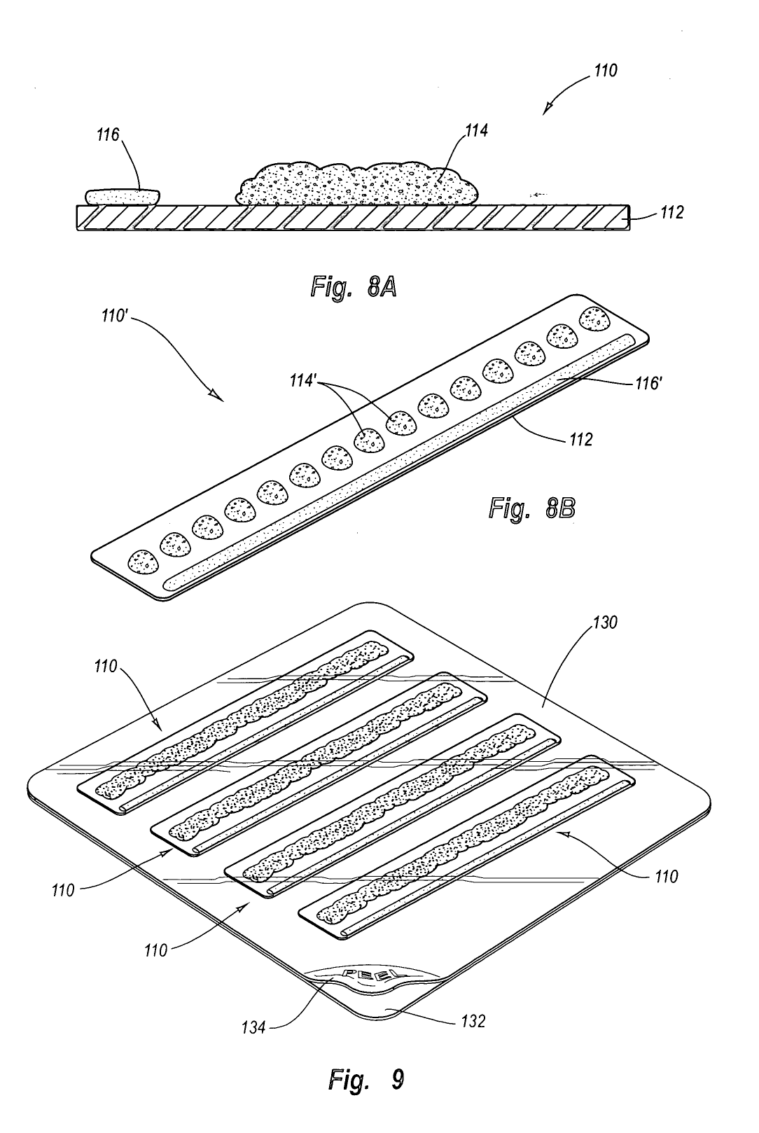

Alternative embodiments of dental treatment compositions and devices in the form of a strip or patch are depicted in FIGS. 7-10. FIG. 7 is a perspective view of a treatment strip or patch 110 comprising a barrier layer 112, which preferably comprises a moisture-resistant material, a dental treatment composition 114, and an adhesive composition or region 116 positioned adjacent to a lingual edge of the barrier layer 112. FIG. 8A is a cross-sectional view of the treatment strip or patch 110 of FIG. 7 taken along cutting line 8A-8A. A first edge 120 of the treatment strip 110 can be designed so as to terminate at or beyond the labial gingival margin of a person's dental arch when in use, and a second edge 122 can be designed so as to terminate at or beyond the lingual gingival margin of the person's dental arch when in use.

FIG. 8B alternatively depicts a dental treatment device 110′ that includes a barrier layer 112, regions or spots of a dental treatment composition 114′, and a strip of an adhesive composition 116 positioned adjacent to a lingual edge of the barrier layer 112. Both the adhesive composition or region 116 and the dental treatment composition 114′ are located adjacent to the barrier layer 112. In this way, the adhesive compositions 116 and dental treatment composition 114′ do not initially touch prior to use, thereby preventing or inhibiting contact between an optional bleaching agent activator within the adhesive composition 116 and a bleaching agent within the treatment composition 114′ prior to use.

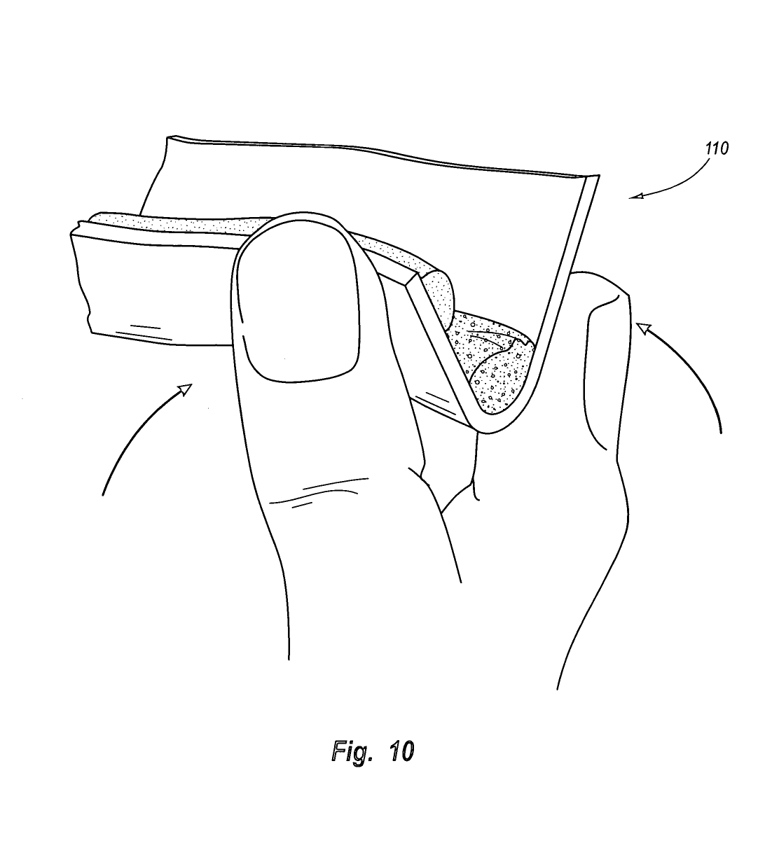

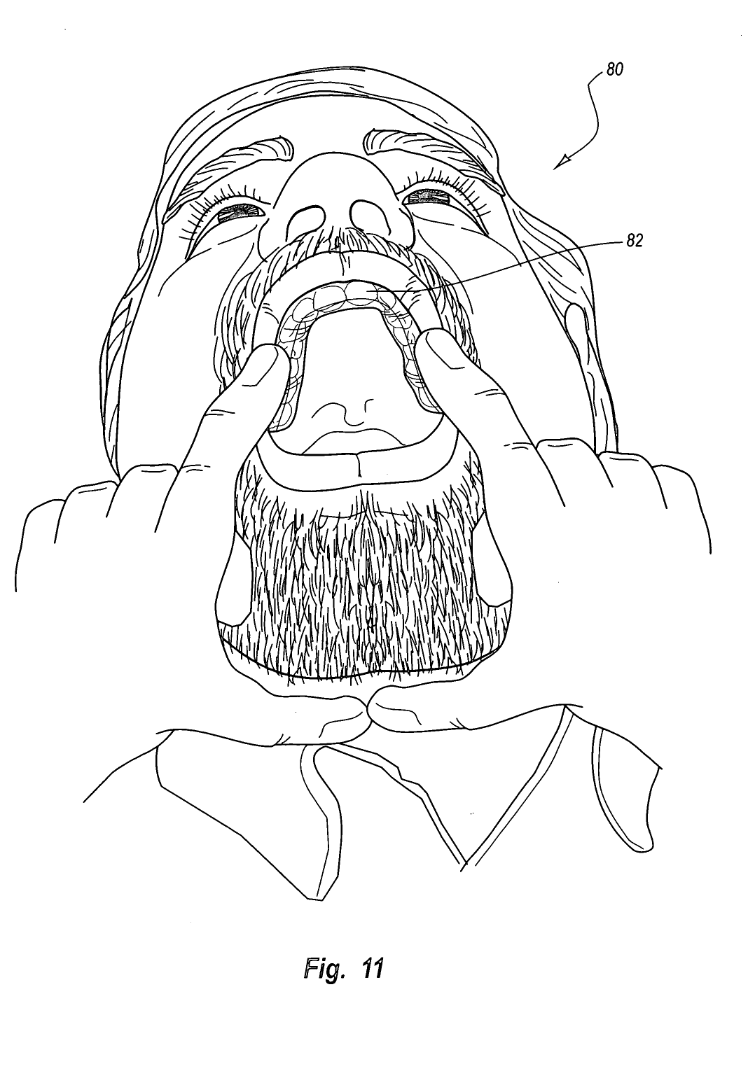

In order to protect treatment strips or patches according to the invention from contaminants during storage and prior to use, they can be packaged within a sealed container or package. As illustrated in FIG. 9, one or more treatment strips or patches 110 can be sealed within a protective package 130 that includes a rigid support layer 132 and a peelable cover 134. When it desired to use the treatment strip or patch 110, the peelable cover 134 is removed and the treatment strip 110 is removed or separated from the support layer 132. In addition to, or instead of, the protective package 130, the treatment strip 110 may alternatively include a removable protective layer (not shown) that is temporarily placed adjacent to the treatment composition and adhesive compositions. When it is desired to use the treatment strip, the removable protective layer is removed so as to expose the treatment and adhesive compositions.

FIG. 10 shows a treatment strip or patch 142 being manipulated (such as by bending, curving or folding) so as to have an approximate V-shaped cross section in order to facilitate placement of the treatment strip or patch 142 over a person's teeth and/or gums.

Notwithstanding the foregoing examples, it will be appreciated that dental treatment devices according to the invention can have any profile and longitudinal shape (e.g., they can be flat or have a 3-dimensional shape; they can have a straight or curved longitudinal profile from one end to the other). The front and rear side walls of a tray may define a trough of any desired cross-sectional shape (e.g., the trough can be trapezoidal, rectangular, or any other desired geometric shape).

The size and shape of dental treatment devices according to the invention can be tailored to more readily fit either a person's upper dental arch or lower dental arch. They can be sized so as to bleach all or merely a subset of a person's teeth. The dental treatment devices may be sufficiently adhesive and flexible so as to readily conform to a wide variety of differently-sized teeth and dental arches. The dental treatment devices may be designed so as to substantially cover the front and lingual surfaces of the teeth to treated. Treating the front and lingual surfaces helps to treat interproximal spaces between a person's teeth, although it is certainly within the scope of the invention to bleach more of one surface than another.

### III. METHODS OF MAKING DENTAL TREATMENT TREATMENT DEVICES

The various components that make up the inventive dental treatment devices according to the invention can be assembled or brought together in any desired order. In the case where both the dental treatment composition and adhesive composition are a gel, one or both compositions can be placed directly adjacent to the barrier layer, whether in the shape of a dental tray, a strip or patch, or some other configuration, to yield the final dental treatment device. The treatment and adhesive compositions can be placed on the barrier layer simultaneously or sequentially. Alternatively, the adhesive composition can be placed against the barrier layer in gel form and then processed to remove at least a portion of the solvent or carrier. Thereafter, the treatment gel is placed adjacent to the barrier layer.

The barrier layer can have a desired shape prior to placing the treatment and protective adhesive compositions as desired to yield the finished treatment device. Alternatively, the barrier can be in the form of a sheet, the treatment and protective adhesive compositions are placed as desired, and the resulting intermediate product cut, shaped or otherwise reconfigured into a desired shape of the dental treatment device.

### IV. METHODS OF USING DENTAL TREATMENT DEVICES

The dental treatment devices according to the invention can be designed to be worn for any desired time period. Increasing the concentration of dental treatment agent generally reduces the time required to effect treatment. Nevertheless, due to the extremely comfortable fit and reliable adhesion between the inventive dental treatment devices and the person's teeth, it is possible to wear such devices for extended periods of time in order to ensure more uniform treatment. They may be designed to be worn while performing normal daily activities, such as talking, eating, drinking, smoking, coughing, smiling, frowning, grimacing, or while sleeping. This greatly decreases their intrusiveness into everyday activities compared to conventional treatment strips, which do not reliably adhere to teeth, or intrusive treatment devices such as large, bulky treatment dental appliances.

The dental treatment devices according to the invention may be worn over a person's upper dental arch, lower dental arch, or both simultaneously. The ability to reliably and comfortably wear dental treatment devices over the upper and lower dental arches simultaneously is another departure from treatment strips, which are not recommended for use in treatment the upper and lower dental arches at the same time.

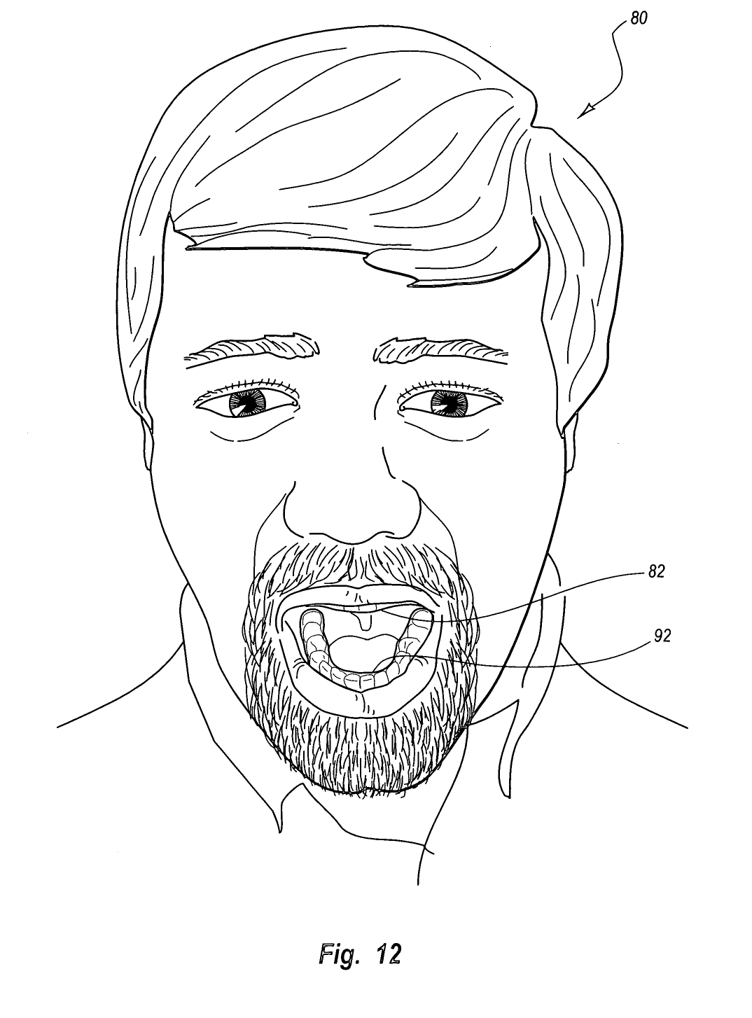

FIG. 11 illustrates a person 80 placing a dental treatment device 82 over the person's upper dental arch. The dental treatment device 82 can be in the form of a dental tray, strip, patch or other desired shape. FIG. 12 shows the person 80 with both a dental treatment device 92 over the person's lower dental arch and the dental treatment device 82 over the upper dental arch. It will be appreciated that the dental treatment devices 82, 92 can be placed over a person's upper and lower dental arches in any desired order.

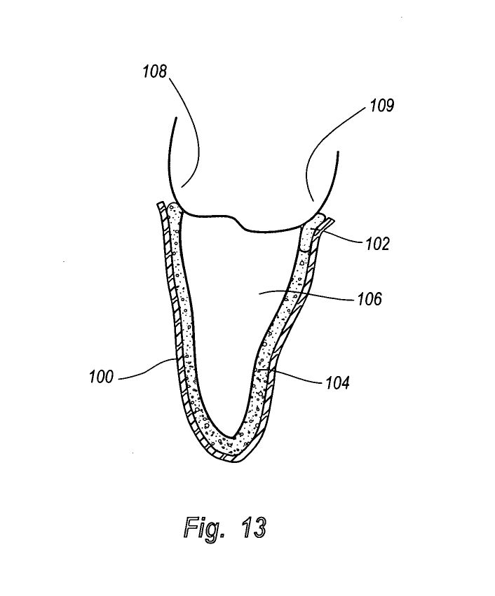

As illustrated in FIGS. 13, a dental treatment device 100 is designed so as to cover both the labial and lingual surfaces of a tooth 106, as well as extend slightly beyond the labial and lingual gingival margins 108, 109. An adhesive composition or region 102 contacts and adheres to oral tissue at the lingual gingival margin 109 so as to more reliably maintain the barrier layer adjacent to the lingual surface of the tooth 106. The treatment composition 104 which is confined to a region where it mainly contacts the labial and lingual surfaces of the patient's tooth 106, though some overlap of the gingival margin and be permitted.

Whereas previously filed U.S. application Ser. No. 10/783,750, filed Feb. 14, 2004, discloses that it may be acceptable or desirable to omit the protective adhesive composition in the lingual region of the treatment device, while only including the protective adhesive composition in the lingual region, it has now been found that it is preferable to do just the opposite: omit an adhesive composition in the lingual region and include a strip of an adhesive composition in the lingual region to offset disruptive lingual forces typically caused by a person's tongue while the treatment device is in use over the person's teeth. The bleaching composition, when properly formulated, does not irritate the gums as previously taught. Thus, there is often no need to protect the gums from the bleaching gel. On the other hand, the tendency of user's to dislodge the lingual side of a barrier layer using their tongue is ubiquitous. Including an adhesive strip on the lingual side greatly enhances adhesion of the barrier layer against tooth and/or soft oral tissues, thereby improving the ability to reliably maintain the barrier layer over lingual tooth surfaces.

To remove the dental treatment device, a user can pry open a corner of the barrier layer using a fingernail or rigid tool and then pull the remainder off. Any residual treatment and/or adhesive composition that remains adhered to the person's teeth can be removed by washing or flushing water over the person's teeth, and/or by brushing. Although the treatment and adhesive compositions can be very adhesive to teeth when protected from excessive moisture, they can be formulated to quickly break down and dissolve when flushed with excess water and/or by gentle mechanical action (e.g., brushing).

The dental treatment devices can be worn for as little as a few minutes or as long as several hours. By way of example, not limitation, a typical treatment session of fast duration may last from about 10 to about 30 minutes. A treatment session of intermediate duration may last from about 30 minutes to about 2 hours. A treatment session of long duration, including professional treatment or overnight treatment while a person is sleeping, may last from about 2 hours to about 12 hours.

Treatment sessions according to the invention may be repeated as many times as needed to obtain a desired degree of tooth treatment. In some cases, a clinical whitening effect has been observed after only 1-3 whitening sessions. A typical treatment regimen will preferably include 1-20 treatment sessions, more preferably 2-15 treatment sessions, and most preferably 3-10 treatment sessions.

### V. DENTAL TREATMENT KITS

For convenience of use, multiple dental treatment devices may be packaged together and sold as a kit. In one embodiment, the number of dental treatment devices provided with each kit may equal the number of sessions that represent a prescribed treatment regimen. Because of the ease of placing the inventive dental treatment devices over a person's teeth, coupled with the reliability with which they adhere to teeth, the likelihood that a particular treatment device will fail, or otherwise not work as intended, is greatly diminished compared to conventional treatment strips.

To efficiently utilize the space within a kit package, multiple dental treatment devices can be stacked or interested together. The dental treatment devices can be sealed collectively or individually as desired. A protective package 30 is depicted in FIG. 3, and a protective package 130 is depicted in FIG. 9. The treatment devices may optionally contain a removable protective layer on an interior surface to protect the treatment composition and protective adhesive composition from contamination or moisture.

### VI. EXAMPLES OF THE PREFERRED EMBODIMENTS

The following are several examples' of dental treatment compositions and adhesive compositions that can used in the manufacture of dental treatment devices. The exemplary formulations and manufacturing conditions are given by way of example, not by limitation, in order to illustrate dental treatment devices that have been found to be useful for treatment a person's teeth. Unless otherwise indicated, all percentages are by weight.

Examples 1-21 are directed to the manufacture of dental bleaching compositions that can be used as the active treatment gel. Examples 22-26 are directed to the manufacture of dental desensitizing compositions that can be used as either the treatment composition or the adhesive composition. Examples 27-29 are directed to the manufacture of medicament compositions that can be used as either the treatment composition or the adhesive composition. Examples 30-37 are directed to the manufacture of adhesive compositions that do not include any active agent. Examples 38-43 are directed to exemplary dental treatment gels that are suitable for use in manufacturing dental treatment devices according to the invention. Examples 44-49 describe further variations of exemplary dental treatment compositions according to the invention.

### Example 1

A dental bleaching gel was formed by mixing together the following components:

| | |
|---|---|
| Carbamide Peroxide | 16% |
| Polyvinyl pyrrolidone (M.W. = 1.3 million) | 38% |
| Water | 46% |

The dental bleaching gel is suitable for use in manufacturing treatment devices according to the invention in combination with a suitable adhesive composition.

### Example 2

A dental bleaching gel was formed by mixing together the following components:

| | |
|---|---|
| Carbamide Peroxide | 16% |
| PolyOx WSR 101(M.W. = 1 million) | 7% |
| Water | 77% |

The dental bleaching gel is suitable for use in manufacturing treatment devices according to the invention in combination with a suitable adhesive composition.

### Example 3

A dental bleaching gel was formed by mixing together the following components:

| | |
|---|---|
| Carbamide Peroxide | 16% |
| Carbopol 974P | 5% |
| Aqueous NaOH (50%) | 6% |
| Water | 73% |

The dental bleaching gel is suitable for use in manufacturing treatment devices according to the invention in combination with a suitable adhesive composition.

### Example 4

A dental bleaching gel was formed by mixing together the following components:

| | |
|---|---|
| Polyethylene Oxide (M.W. = 100,000) | 20% |
| Glycerin | 2.5% |
| Sodium Percarbonate | 2.4% |
| Water | 75.1% |

The dental bleaching gel is suitable for use in manufacturing treatment devices according to the invention in combination with a suitable adhesive composition.

### Example 5

A dental bleaching gel was formed by mixing together the following components:

| | |
|---|---|
| Carbamide Peroxide | 10% |
| Water | 25% |
| Ethanol | 25% |
| Polyvinyl pyrrolidone (M.W. = 1.3 million) | 38% |
| Glycerin | 73% |

The dental bleaching gel is suitable for use in manufacturing treatment devices according to the invention in combination with a suitable adhesive composition.

### Example 6

A dental bleaching gel was formed by mixing together the following components:

| | |
|---|---|
| Carbamide Peroxide | 10% |
| Water | 21% |
| Ethanol | 21% |
| Kollidon VA 64 (M.W. = 60,000) | 40% |
| Carboxy methyl cellulose | 3% |
| PEG 600 | 5% |

The dental bleaching gel is suitable for use in manufacturing treatment devices according to the invention in combination with a suitable adhesive composition.

### Example 7

A dental bleaching gel was formed by mixing together the following components:

| | |
|---|---|
| Carbamide Peroxide | 11.6% |
| Ethanol | 55.8% |
| Kollidon VA 90 F (M.W. = 1.3 million) | 24.4% |
| Carboxy methyl cellulose | 2.3% |
| PEG 600 | 5.8% |

The dental bleaching gel is suitable for use in manufacturing treatment devices according to the invention in combination with a suitable adhesive composition.

### Example 8

A dental bleaching gel was formed by mixing together the following components:

| | |
|---|---|
| Carbamide Peroxide | 10% |
| Ethanol | 65% |
| Kollidon VA 90 F (M.W. = 1.3 million) | 20% |
| PEG 600 | 5% |

The dental bleaching gel is suitable for use in manufacturing treatment devices according to the invention in combination with a suitable adhesive composition.

### Example 9

A dental bleaching gel was formed by mixing together the following components:

| | |
|---|---|
| Carbamide Peroxide | 10% |
| Ethanol | 64% |
| Kollidon VA 90 F (M.W. = 1.3 million) | 25% |
| PEG 600 | 1% |

The dental bleaching gel is suitable for use in manufacturing treatment devices according to the invention in combination with a suitable adhesive composition.

### Example 10

A dental bleaching gel was formed by mixing together the following components:

| | |
|---|---|
| Carbamide Peroxide | 10% |
| Ethanol | 64% |
| Kollidon VA 90 F (M.W. = 1.3 million) | 23% |
| PEG 600 | 1% |
| Aerosil 200 | 2% |

The dental bleaching gel is suitable for use in manufacturing treatment devices according to the invention in combination with a suitable adhesive composition.

### Example 11

A dental bleaching gel was formed by mixing together the following components:

| | |
|---|---|
| Carbamide Peroxide | 10% |
| Ethanol | 66.9% |
| Kollidon VA 90 F (M.W. = 1.3 million) | 20% |
| PEG 600 | 0.1% |
| Aerosil 200 | 3% |

The dental bleaching gel is suitable for use in manufacturing treatment devices according to the invention in combination with a suitable adhesive composition.

### Example 12

A dental bleaching gel was formed by mixing together the following components:

| | |
|---|---|
| Carbamide Peroxide | 10% |
| PolyOx (M.W. = 1 million) | 7.5% |
| Water | 75.5% |
| Glycerin | 5% |
| Aerosil 200 | 2% |

The dental bleaching gel is suitable for use in manufacturing treatment devices according to the invention in combination with a suitable adhesive composition.

### Example 13

A dental bleaching gel was formed by mixing together the following components:

| | |
|---|---|
| Carbamide Peroxide | 10% |
| Kollidon 90 F (M.W. = 1.3 million) | 10% |
| Kollidon 30 (M.W. = 50,000) | 20% |
| Water | 53% |
| Glycerin | 5% |
| Aerosil 200 | 2% |

The dental bleaching gel is suitable for use in manufacturing treatment devices according to the invention in combination with a suitable adhesive composition.

### Example 14

A dental bleaching gel was formed by mixing together the following components:

| | |
|---|---|
| Carbamide Peroxide | 10% |
| Kollidon 90 F (M.W. = 1.3 million) | 27% |
| Water | 50% |
| Glycerin | 7% |
| Aerosil 200 | 6% |

The dental bleaching gel is suitable for use in manufacturing treatment devices according to the invention in combination with a suitable adhesive composition.

### Example 15

A dental bleaching gel was formed by mixing together the following components:

| | |
|---|---|
| Carbamide Peroxide | 10% |
| Kollidon 90 F (M.W. = 1.3 million) | 28% |
| Water | 50% |
| Glycerin | 7% |
| Aerosil 200 | 5% |

The dental bleaching gel is suitable for use in manufacturing treatment devices according to the invention in combination with a suitable adhesive composition.

### Example 16

A dental bleaching gel was formed by mixing together the following components:

| | |
|---|---|
| Carbamide Peroxide | 15% |
| Polyvinyl pyrrolidone (M.W. = 1.3 million) | 32% |
| Water | 12.8% |
| Ethanol | 20% |
| Glycerin | 10% |
| Aerosil 200 | 5% |
| Calcium EDTA | 0.2% |
| Sodium Lauryl Sulfate | 5% |

The dental bleaching gel is suitable for use in manufacturing treatment devices according to the invention in combination with a suitable adhesive composition.

### Example 17

A dental bleaching gel was formed by mixing together the following components:

| | |
|---|---|
| Carbamide Peroxide | 15% |
| Polyvinyl pyrrolidone (M.W. = 1.3 million) | 26% |
| Water | 16.8% |
| Ethanol | 25% |
| Glycerin | 15% |
| Calcium EDTA | 0.2% |
| Sodium Lauryl Ether Sulfate | 2% |

The dental bleaching gel is suitable for use in manufacturing treatment devices according to the invention in combination with a suitable adhesive composition.

### Example 18

A dental bleaching gel was formed by mixing together the following components:

| | |
|---|---|
| Carbamide Peroxide | 15% |
| Polyvinyl pyrrolidone (M.W. = 1.3 million) | 32% |
| Water | 13.8% |
| Ethanol | 20% |
| Glycerin | 12% |
| Aerosil 200 | 5% |
| Calcium EDTA | 0.2% |
| Silwet L-7001 | 2% |

The dental bleaching gel is suitable for use in manufacturing treatment devices according to the invention in combination with a suitable adhesive composition.

### Example 19

A dental bleaching gel was formed by mixing together the following components:

| | |
|---|---|
| Calcium Peroxide | 20% |
| Carbamide Peroxide | 4% |
| Polyvinyl pyrrolidone (M.W. = 1.3 million) | 20% |
| Water | 11.8% |
| Ethanol | 20% |
| Glycerin | 18% |
| Aerosil 200 | 5% |
| Calcium EDTA | 0.2% |
| Sodium Lauryl Sulfate | 2% |

The dental bleaching gel is suitable for use in manufacturing treatment devices according to the invention in combination with a suitable adhesive composition.

### Example 20

A dental bleaching gel was formed by mixing together the following components:

| | |
|---|---|
| Carbamide Peroxide | 10% |
| Kollidon 90 (M.W. = 1.3 million) | 18.7% |
| Water | 42.3% |
| Ethanol | 13.3% |
| Glycerin | 12% |
| Aerosil 200 | 3.3% |
| Sodium Lauryl Sulfate | 0.33% |

The resulting bleaching gel is suitable for use in manufacturing treatment devices according to the invention in combination with a suitable adhesive composition.

### Example 21

A dental bleaching gel was formed by mixing together the following components:

| | |
|---|---|
| Carbamide Peroxide | 7.1% |
| Kollidon 90 (M.W. = 1.3 million) | 25% |
| Water | 10.7% |
| Ethanol | 50.7% |
| Glycerin | 2.9% |
| Aerosil 200 | 3.6% |

The resulting bleaching gel is suitable for use in manufacturing treatment devices according to the invention in combination with a suitable adhesive composition.

### Example 22

A dental desensitizing composition was formed by mixing together the following components:

| | |
|---|---|
| Sodium Fluoride | 0.25% |
| Polyvinyl pyrrolidone (M.W. = 1.3 million) | 30% |
| Water | 69.75% |

The desensitizing composition can be used in gel form as a treatment composition in combination with an adhesive composition to yield a dental treatment device. Alternatively, it may be used in either gel form or substantially solid form as an adhesive composition positioned near a lingual edge of a barrier layer.

### Example 23

A dental desensitizing composition was formed by mixing together the following components:

| | |
|---|---|
| Sodium Citrate | 5% |
| Polyvinyl pyrrolidone (M.W. = 1.3 million) | 20% |
| Water | 75% |

The desensitizing composition can be used in gel form as a treatment composition in combination with an adhesive composition to yield a dental treatment device. Alternatively, it may be used in either gel form or substantially solid form as an adhesive composition positioned near a lingual edge of a barrier layer.

### Example 24

A dental desensitizing composition was formed by mixing together the following components:

| | |
|---|---|
| Potassium Nitrate | 3% |
| Polyvinyl pyrrolidone (M.W. = 1.3 million) | 15% |
| Ethanol | 30% |
| Water | 52% |

The desensitizing composition can be used in gel form as a treatment composition in combination with an adhesive composition to yield a dental treatment device. Alternatively, it may be used in either gel form or substantially solid form as an adhesive composition positioned near a lingual edge of a barrier layer.

### Example 25

A dental desensitizing composition was formed by mixing together the following components:

| | |
|---|---|
| Potassium Nitrate | 0.5% |
| Sodium Fluoride | 0.25% |
| Polyvinyl pyrrolidone (M.W. = 1.3 million) | 32% |
| Ethanol | 30% |
| Water | 37.25% |

The desensitizing composition can be used in gel form as a treatment composition in combination with an adhesive composition to yield a dental treatment device. Alternatively, it may be used in either gel form or substantially solid form as an adhesive composition positioned near a lingual edge of a barrier layer.

### Example 26

A dental desensitizing composition was formed by mixing together the following components:

| | |
|---|---|
| Potassium Nitrate | 0.5% |
| Sodium Fluoride | 0.25% |
| Carbamide Peroxide | 15% |
| Polyvinyl pyrrolidone (M.W. = 1.3 million) | 33% |
| Water | 51.25% |

The desensitizing composition can be used in gel form as a treatment composition in combination with an adhesive composition to yield a dental treatment device. Alternatively, it may be used in either gel form or substantially solid form as an adhesive composition positioned near a lingual edge of a barrier layer.

### Example 27

A medicament composition was formed by mixing together the following components:

| | |
|---|---|
| Chlorhexidine Gluconate | 2% |
| Polyvinyl pyrrolidone (M.W. = 1.3 million) | 30% |
| Ethanol | 33% |
| Water | 35% |

The medicament composition can be used in gel form as a treatment composition in combination with an adhesive composition to yield a dental treatment device. Alternatively, it may be used in either gel form or substantially solid form as an adhesive composition positioned near a lingual edge of a barrier layer.

### Example 28

A medicament composition was formed by mixing together the following components:

| | |
|---|---|
| Cetylpyridinium Chloride | 2% |
| Ethanol | 28% |
| Polyvinyl pyrrolidone (M.W. = 1.3 million) | 35% |
| Water | 35% |

The medicament composition can be used in gel form as a treatment composition in combination with an adhesive composition to yield a dental treatment device. Alternatively, it may be used in either gel form or substantially solid form as an adhesive composition positioned near a lingual edge of a barrier layer.

### Example 29

A medicament composition was formed by mixing together the following components:

| | |
|---|---|
| Phenol | 3% |
| Polyvinyl pyrrolidone (M.W. = 1.3 million) | 35% |
| Ethanol | 62% |

The medicament composition can be used in gel form as a treatment composition in combination with an adhesive composition to yield a dental treatment device. Alternatively, it may be used in either gel form or substantially solid form as an adhesive composition positioned near a lingual edge of a barrier layer.

### Example 30

An adhesive composition suitable for use in making a dental treatment device was formed by mixing together the following components:

| | |
|---|---|
| Water | 25% |
| Ethanol | 30% |
| Glycerin | 10% |
| Polyvinyl pyrrolidone (M.W. = 1.3 million) | 30% |
| Aerosil 200 | 5% |

The adhesive composition can be used in gel or substantially solid form in combination with a dental treatment gel to manufacture dental treatment devices according to the invention.

### Example 31

An adhesive composition suitable for use in making a dental treatment device was formed by mixing together the following components:

| | |
|---|---|
| Water | 20% |
| Ethanol | 30% |
| Glycerin | 15% |
| Polyvinyl pyrrolidone (M.W. = 1.3 million) | 30% |
| Aerosil 200 | 5% |

The adhesive composition can be used in gel or substantially solid form in combination with a dental treatment gel to manufacture dental treatment devices according to the invention.

### Example 32

An adhesive composition suitable for use in making a dental treatment device was formed by mixing together the following components:

| | |
|---|---|
| Water | 20% |
| Ethanol | 40% |
| Glycerin | 10% |
| Polyvinyl pyrrolidone (M.W. = 1.3 million) | 30% |

The adhesive composition can be used in gel or substantially solid form in combination with a dental treatment gel to manufacture dental treatment devices according to the invention.

### Example 33

An adhesive composition suitable for use in making a dental treatment device was formed by mixing together the following components:

| | |
|---|---|
| Ethanol | 60.6% |
| Glycerin | 5.1% |
| Polyvinyl pyrrolidone (M.W. = 1.3 million) | 30% |
| Aerosil 200 | 4.3% |

The adhesive composition can be used in gel or substantially solid form in combination with a dental treatment gel to manufacture dental treatment devices according to the invention.

### Example 34

An adhesive composition suitable for use in making a dental treatment device was formed by mixing together the following components:

| | |
|---|---|
| Ethanol | 61.9% |
| Glycerin | 9.5% |
| Polyvinyl pyrrolidone (M.W. = 1.3 million) | 23.8% |
| Aerosil 200 | 4.8% |

The adhesive composition can be used in gel or substantially solid form in combination with a dental treatment gel to manufacture dental treatment devices according to the invention.

### Example 35

An adhesive composition suitable for use in making a dental treatment device was formed by mixing together the following components:

| | |
|---|---|
| Ethanol | 63.6% |
| Glycerin | 9.1% |
| Polyvinyl pyrrolidone (M.W. = 1.3 million) | 27.3% |

The adhesive composition can be used in gel or substantially solid form in combination with a dental treatment gel to manufacture dental treatment devices according to the invention.

### Example 36

An adhesive composition suitable for use in making a dental treatment device was formed by mixing together the following components:

| | |
|---|---|
| Ethanol | 44% |
| Polyvinyl pyrrolidone (M.W. = 1.3 million) | 34% |
| Glycerin | 14% |
| Sodium Lauryl Sulfate | 3% |
| Sucralose | 1% |
| Artificial Peach Flavor | 4% |

The adhesive composition can be used in gel or substantially solid form in combination with a dental treatment gel to manufacture dental treatment devices according to the invention.

### Example 37

A desensitizing and remineralizing composition suitable was formed by mixing together the following components:

| | |
|---|---|
| Ethanol | 31.95% |
| Water | 10% |
| Polyvinyl pyrrolidone (M.W. > 1 million) | 27% |
| Polyvinyl pyrrolidone (M.W. ≈ 60,000) | 10% |
| Sodium Lauryl Sulfate | 0.5% |
| Glycerin | 15% |
| Sucralose (25% solution) | 0.5% |
| Peach Flavor | 4% |
| Potassium Nitrate | 0.8% |
| Sodium Fluoride | 0.25% |

The desensitizing and remineralizing composition can be used in gel form as a treatment composition in combination with an adhesive composition to yield a dental treatment device. Alternatively, it may be used in either gel form or substantially solid form as an adhesive composition positioned near a lingual edge of a barrier layer.

### Example 38

A dental bleaching gel was formed by mixing together the following components:

| | |
|---|---|
| Carboxy Methyl Cellulose (sodium salt) | 2% |
| Carbamide Peroxide | 22.5% |
| Glycerin | 28% |
| Water | 16.4% |
| Sodium Saccharine Powder | 2% |
| Sodium EDTA | 0.1% |
| Cabosil M-5 (SiO₂) | 7% |
| Peach Flavor | 2% |
| Polyethylene Glycol (M.W. = 20,000) | 20% |

The dental bleaching gel was placed within a flexible, thin-walled dental tray. An adhesive composition is placed near the lingual rim of the tray to yield a dental treatment device according to the invention. Alternatively, the dental bleaching gel and adhesive composition are placed onto a barrier layer in the form of a strip or patch to yield a dental treatment device according to the invention.

### Example 39

A dental bleaching gel was formed by mixing together the following components:

| | |
|---|---|
| Water | 19.2% |
| Edetate Disodium | 0.1% |
| Carbamide Peroxide | 18.5% |
| Xylitol C | 7% |
| Glycerin | 25.4% |
| CARBOPOL 974 | 5.3% |
| NaOH (50% in water) | 4.5% |
| Carboxy Methyl Cellulose | 4% |
| Kollidon 90F | 10% |
| Peach Flavor | 3% |
| Sucralose (25% in water) | 3% |

The dental bleaching gel is suitable for use in manufacturing treatment devices according to the invention in combination with a suitable adhesive composition.

### Example 40

A dental bleaching gel was formed by mixing together the following components:

| | |
|---|---|
| Water | 18% |
| Edetate Disodium | 0.1% |
| Carbamide Peroxide | 18.5% |
| Sucralose (25% in water) | 3% |
| Glycerin | 41.6% |
| CARBOPOL 974 | 5.3% |
| NaOH (50% in water) | 4.5% |
| Kollidon 90F | 2% |
| Carboxy Methyl Cellulose | 4% |
| Peach Flavor | 3% |

The dental bleaching gel is suitable for use in manufacturing treatment devices ng to the invention in combination with a suitable adhesive composition.

### Example 41

A dental bleaching gel was formed by mixing together the following components:

| | |
|---|---|
| Water | 18% |
| EDTA | 0.1% |
| Carbamide Peroxide | 22% |
| Sucralose (25% in water) | 2% |
| Glycerin | 37.1% |
| CARBOPOL 974 | 5.3% |
| NaOH (50% in water) | 4.5% |
| Kollidon 90F | 2% |
| Carboxy Methyl Cellulose | 5% |
| Peach Flavor | 4% |

The dental bleaching gel is suitable for use in manufacturing treatment devices according to the invention in combination with a suitable adhesive composition.

### Example 42

A dental bleaching gel was formed by mixing together the following components:

| | |
|---|---|
| Water | 18% |
| EDTA | 0.1% |
| Carbamide Peroxide | 22% |
| Sucralose (25% in water) | 2% |
| Glycerin | 40.1% |
| CARBOPOL 974 | 5.3% |
| NaOH (50% in water) | 4.5% |
| Kollidon 90F | 2% |
| Carboxy Methyl Cellulose | 5% |
| Peppermint Oil | 1% |

The dental bleaching gel is suitable for use in manufacturing treatment devices according to the invention in combination with a suitable adhesive composition.

### Example 43

A dental bleaching gel was formed by mixing together the following components:

| | |
|---|---|
| Water | 22.5% |
| EDTA | 0.1% |
| Carbamide Peroxide | 18.5% |
| Sucralose (25% in water) | 0.75% |
| Glycerin | 41.6% |
| CARBOPOL 974 | 5.3% |
| NaOH (50% in water) | 2.25% |
| Polyvinyl Pyrrolidone (M.W. > 1 million) | 2% |
| Carboxy Methyl Cellulose | 4% |
| Flavor (peach, watermelon or peppermint) | 3% |

The dental bleaching gel is suitable for use in manufacturing treatment devices according to the invention in combination with a suitable adhesive composition.

### Example 44

Any of the adhesive compositions of Examples 22-37 are modified by adding one or more of a colorant, gingival soothing agent, isotonic solution-forming salt, anesthetic, antioxidant, flavoring agent, preservative, mouth freshening agent, detergent, inorganic thickening agent, remineralizing agent, antiplaque agent, anti-tartar agent, freshening agent, or antioxidant.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dental treatment device, comprising:
a barrier layer having a labial rim and a lingual rim and a size and shape so as to substantially cover labial and lingual tooth surfaces during use, said barrier layer being substantially devoid of structures corresponding to the size and shape of a person's unique dentition so that said barrier layer is designed to comfortably fit over a plurality of differently-sized dental arches corresponding to different people;
a treatment gel positioned relative to said barrier layer so as to contact labial and lingual surfaces of a person's teeth during use, said treatment gel comprising an oral treatment agent, a tissue adhesion agent, and a liquid or gel carrier; and
a hydrophilic adhesive composition positioned near said lingual rim of said barrier layer so as to reliably maintain said barrier layer against lingual tooth surfaces during use, said adhesive composition comprising at least one tissue adhesion agent that includes at least one hydrophilic polymer that is adhesive to oral tissue.

2. A dental treatment device as defined in claim 1, said barrier layer being flexible so as to readily conform to the shape of a person's teeth during use.

3. A dental treatment device as defined in claim 1, said barrier layer having a cross-sectional thickness in a range of about 0.025 mm to about 1.5 mm.

4. A dental treatment device as defined in claim 1, said barrier layer having a cross-sectional thickness in a range of about 0.05 mm to about 1 mm.

5. A dental treatment device as defined in claim 1, said barrier layer having a tray-like configuration comprising a least two sidewalls that define a trough within which said treatment gel and said adhesive composition reside prior to use.

6. A dental treatment device as defined in claim 5, said barrier layer being sufficiently thin and flexible so as to be unable to maintain said tray-like configuration absent external support, the dental treatment device further comprising a removable exoskeleton that maintains said barrier layer in said tray-like configuration prior to use.

7. A dental treatment device as defined in claim 1, said barrier layer comprising a strip or patch prior to use.

8. A dental treatment device as defined in claim 1, said barrier layer designed so as to approximately terminate at or extend beyond a person's gingival margin during use.

9. A dental treatment device as defined in claim 1, said treatment composition being sticky and viscous.

10. A dental treatment device as defined in claim 1, said tissue adhesion agent comprising at least one of polyvinyl pyrrolidone (PVP), carboxypolymethylene, polyethylene oxide, polyacrylic acid, copolymer of polyacrylic acid, polyacrylate, polyacrylamide, copolymer of polyacrylic acid and polyacrylamide, PVP-vinyl acetate copolymer, carboxymethylcellulose, carboxypropylcellulose, polysaccharide gum, or protein.

11. A dental treatment device as defined in claim 1, said oral treatment agent comprising at least one member selected from the group comprising dental bleaching agents, dental desensitizing agents, stabilizing agents, remineralizing agent, antimicrobial agents, antiplaque agents, and anti-tartar agents.

12. A dental treatment device as defined in claim 1, said adhesive composition being a sticky and viscous gel.

13. A dental treatment device as defined in claim 1, said adhesive composition being substantially solid prior to use and becoming more adhesive to teeth when moistened with saliva or water.

14. A dental treatment device as defined in claim 1, said hydrophilic polymer within said adhesive composition comprising at least one of polyvinyl pyrrolidone (PVP), carboxypolymethylene, polyethylene oxide, polyacrylic acid, copolymer of polyacrylic acid, polyacrylate, polyacrylamide, copolymer of polyacrylic acid and polyacrylamide, PVP-vinyl acetate copolymer, carboxymethylcellulose, carboxypropylcellulose, polysaccharide gum, or protein.

15. A dental treatment device as defined in claim 1, said adhesive composition further comprising at least one member selected from the group comprising dental dental bleaching agents, tooth desensitizing agents, remineralizing agent, antimicrobial agents, preservatives, antiplaque agents, anti-tartar agents, gingival soothing agents, anesthetics, antioxidants, flavorants, mouth freshening agents, detergents, and colorants.

16. A dental treatment device, comprising:
a dental tray comprising a thin, flexible and moisture resistant material that readily conforms to a person's dental arch during use,
said dental tray having a front side wall configured to lie adjacent to labial tooth surfaces, a rear side wall configured to lie adjacent to lingual tooth surfaces, and a trough therebetween,
said barrier layer being substantially devoid of structures corresponding to the size and shape of a person's unique dentition so that said barrier layer is designed to comfortably fit over a plurality of differently-sized dental arches corresponding to different people;
a treatment gel positioned within said trough of said dental tray so as to contact labial and lingual surfaces of a person's teeth during use, said treatment gel comprising an oral treatment agent, a tissue adhesion agent, and a liquid or gel carrier; and
a hydrophilic adhesive composition positioned near a rim of said rear side wall of said dental tray so as to reliably maintain said dental tray against lingual tooth surfaces during use, said adhesive composition comprising at least one tissue adhesion agent that includes at least one hydrophilic polymer that is adhesive to oral tissue.

17. A dental treatment device as defined in claim 16, said treatment gel being sticky and viscous.

18. A dental treatment device as defined in claim 16, said adhesive composition comprising a sticky and viscous gel.

19. A dental treatment device as defined in claim 16, said adhesive composition being substantially solid prior to use and becoming more adhesive to teeth or gums when moistened with saliva or water.

20. A method of manufacturing a dental treatment device, comprising:
providing a thin, flexible barrier layer;
applying a treatment gel adjacent to said barrier layer so that said treatment gel contacts labial and lingual tooth surfaces when said barrier layer is placed over a person's teeth; and
applying a strip of an adhesive composition near a lingual rim of said barrier layer that is designed to reliably maintain said barrier layer adjacent to lingual tooth surfaces during use.

21. A method as defined in claim 20, wherein said adhesive composition is a sticky and viscous gel.

22. A method as defined in claim 20, wherein said adhesive composition is substantially solid, the method further comprising applying said adhesive composition initially as a gel followed by removing at least portion of a volatile solvent from said gel by evaporation so as to yield said substantially solid adhesive composition.
